(19) United States
(12) Patent Application Publication
(10) Pub. No.: US 2024/0219901 A1
(43) Pub. Date: Jul. 4, 2024

(54) INFORMATION PROCESSING SYSTEM, TRANSMISSION SYSTEM, INFORMATION PROCESSING METHOD, AND VALVE SYSTEM

(71) Applicant: KITZ CORPORATION, TOKYO (JP)

(72) Inventors: Isao NISHIZAWA, Chiba (JP); Yuu INOUE, Chiba (JP); Motohiro FURUYA, Chiba (JP)

(21) Appl. No.: 18/566,810

(22) PCT Filed: Jun. 10, 2022
(86) PCT No.: PCT/JP2022/023467

§ 371 Date: Dec. 4, 2023

(30) Foreign Application Priority Data
Jun. 10, 2021 (JP) 2021-097350

(51) Int. Cl. G05B 23/02; F16K 37/00

(52) U.S. Cl. CPC G05B 23/0283; F16K 37/0083

(57) ABSTRACT

Degrees of abnormality of a valve and an actuator that drives the valve are estimated. An information processing system (100) according to the present invention includes an acquisition unit (110) configured to acquire angular velocity data of a rotation of a rotating shaft, the angular velocity data being detected by an angular velocity sensor, and an estimation unit (120) configured to estimate a degree of abnormality of each of an actuator (2) and a valve (3) by referring to the angular velocity data acquired by the acquisition unit (110).

### TECHNICAL FIELD

The present invention relates to an information processing system, a transmission system, an information processing method, and a valve system configured to estimate a degree of abnormality of each of a valve and an actuator that drives the valve on the basis of angular velocity data of a rotating shaft.

### BACKGROUND ART

Generally, in various locations including large-scale facilities, such as various plants and buildings, or small-scale structures, such as houses and shops, various piping facilities including various pipes, valves, and various actuators for automatically controlling these valves are provided. In these piping facilities, demanding rotary valves, such as ball valves and butterfly valves, for example, are 90-degree rotation type (quarter-turn type) rotary valves. As actuators for driving these, pneumatic actuators are often mounted, which are simple in configuration, easily made compact in size, and even excellent in cost.

Typically, for automatic control of devices such as the valves and the actuators, and for management and maintenance of operating conditions, and the like, such piping facilities also require means for monitoring the state of these devices. In recent years, there also has been a growing demand for not only state monitoring of the valves and the actuators in piping facilities but also failure prediction and lifetime diagnosis of these devices, more precise state detection capabilities such as appropriate evaluation and differentiation for each failure and symptom at a product and component level, and systems capable of managing and controlling these devices from various perspectives on the basis of the detection results thereof.

For example, Patent Document 1 discloses a main valve disposed in the middle of a pipe and a drive device that opens and closes the main valve by driving a valve shaft coupled to the main valve in accordance with a fluid pressure of a driving fluid, and discloses a technique for determining an abnormality of the drive device on the basis of a detection result of a driving state sensor. As one such driving state sensor, a sensor that detects a temperature and a humidity inside a cylinder provided in the drive device is provided.

The present inventors have also conducted intensive studies on valve maintenance and management for many years. For example, Patent Document 2 discloses an example of a system that monitors and diagnoses the state and predicts the lifetime of the valve, on the basis of angular velocity data of a valve shaft that opens and closes a valve. In Patent Document 2, a ball valve is equipped with a monitoring unit, and a gyro sensor built in the monitoring unit acquires angular velocity data of a valve shaft that opens and closes a ball. The acquired angular velocity data is graphed, and various diagnostic processes including a lifetime prediction process are executed on the basis of shape or pattern analysis of the graphed data. As an example, a reduction in a static friction force of a ball seat is estimated on the basis of the angular velocity data.

### CITATION LIST

### Patent Literature

Patent Document 1: JP 6783490 B
Patent Document 2: WO 2019/235599 A1

### SUMMARY OF INVENTION

### Technical Problem

In an aspect in which the valve and the actuator that is a drive device of the valve are installed outdoors, a malfunction often occurs in the actuator due to the effects of a decrease in outside air temperature, rainwater, or moisture contained in the air. The present inventors that have learned this fact make efforts to develop a system capable of state identification and failure prediction of valves and actuators and completes the present invention.

That is, an object of an aspect of the present invention is to implement an information processing system, a transmission system, an information processing method, and a valve system configured to estimate a degree of abnormality of each of a valve and an actuator from a transition in angular velocity data.

### Solution to Problem

To solve the problems described above, an information processing system according to an aspect of the present invention includes an acquisition unit configured to acquire angular velocity data of a rotation of a rotating shaft, the angular velocity data being detected by an angular velocity sensor, in a valve unit in which the rotating shaft is rotated by an actuator to rotate a valve body of a valve and an estimation unit configured to estimate a degree of abnormality of each of the actuator and the valve by referring to the angular velocity data acquired by the acquisition unit.

To solve the problems described above, a transmission system according to an aspect of the present invention is a transmission system configured to transmit, to an external device, angular velocity data of a rotation of a rotating shaft, the angular velocity data being detected by an angular velocity sensor, in a valve unit in which the rotating shaft is rotated by an actuator to rotate a valve body of a valve in order to estimate a degree of abnormality of each of the actuator and the valve by referring to the angular velocity data. The transmission system includes a transmission control unit configured to control transmission of the angular velocity data. The transmission control unit transmits, of a plurality of the angular velocity data detected by the angular velocity sensor, only some of angular velocity data to the external device in response to one or both of a specific time period and the number of times the angular velocity sensor detects the angular velocity data of the rotating shaft reaching a specific count.

To solve the problems described above, an information processing method according to an aspect of the present invention includes acquiring angular velocity data of a rotation of a rotating shaft, the angular velocity data being detected by an angular velocity sensor, in a valve unit in which the rotating shaft is rotated by an actuator to rotate a valve body of a valve and estimating a degree of abnormality of each of the actuator and the valve by referring to the angular velocity data acquired by the acquiring.

To solve the problems described above, a valve system according to an aspect of the present invention includes a valve unit including a valve configured to open and close a flow path by rotating a valve body, an actuator configured to rotate a rotating shaft for rotating the valve body, and one or both of the information processing system described above and the transmission system described above.

### Advantageous Effects of Invention

An aspect of the invention can estimate a degree of abnormality of each of a valve and an actuator from a transition of angular velocity data of a rotating shaft detected by a gyro sensor.

### BRIEF DESCRIPTION OF DRAWINGS

FIG. 1 is a diagram illustrating a configuration of a valve system according to an aspect of the present invention.

FIG. 2 is a diagram illustrating a graph of angular velocity data used for estimating degrees of abnormality of a valve and an actuator of a valve unit implemented in an information processing system according to an embodiment of the present invention and a graph of comparative angular velocity data.

FIG. 3 is a diagram illustrating an example of a graph of angular velocity data used in the information processing system according to an embodiment of the present invention.

FIG. 4 is a diagram illustrating an example of a graph of angular velocity data used in the information processing system according to an embodiment of the present invention.

FIG. 5 is a diagram illustrating an example of graphs of angular velocity data of a valve unit and an actuator in a normal state and in an abnormal state in a scotch yoke valve unit used in the information processing system according to an embodiment of the present invention.

FIG. 6 is a diagram illustrating an example of graphs of angular velocity data of a valve unit and an actuator in a normal state and an abnormal state in a rack-and-pinion valve unit used in the information processing system according to an embodiment of the present invention.

FIG. 7 is a diagram illustrating an example of a graph of angular velocity data used in the information processing system according to an embodiment of the present invention.

FIG. 8 is a diagram illustrating an example of a graph of angular velocity data used in the information processing system according to an embodiment of the present invention.

FIG. 9 is a diagram illustrating an example of a graph of angular velocity data used in the information processing system according to an embodiment of the present invention.

FIG. 10 is a flowchart illustrating an operation flow of the information processing system according to an embodiment of the present invention.

FIG. 11 is a flowchart illustrating a processing flow of contents of a portion of an estimation process of the operation flow of the information processing system according to an embodiment of the present invention.

FIG. 12 is a flowchart illustrating details of a portion of the processing flow of FIG. 11.

FIG. 13 is an external view of a valve unit included in the valve system according to an aspect of the present invention.

FIG. 14 is a top view of the valve unit illustrated in FIG. 13.

FIG. 15 is a block diagram illustrating a configuration of a sensor unit 1 attached to the valve unit illustrated in FIG. 13.

FIG. 16 is a cross-sectional view of the valve unit illustrated in FIG. 13.

FIG. 17 is a cross-sectional view of a valve chamber portion of the valve unit illustrated in FIG. 13 at a valve opening degree of 0 (fully closed).

FIG. 18 is a cross-sectional view of the valve chamber portion of the valve unit illustrated in FIG. 13 at a valve opening degree of approximately 10 degrees.

FIG. 19 is a cross-sectional view of a valve chamber portion of the valve unit illustrated in FIG. 13 at a valve opening degree of approximately 20 degrees.

FIG. 20 is a cross-sectional view of a valve chamber portion of the valve unit illustrated in FIG. 13 at a valve opening degree of approximately 80 degrees.

FIG. 21 is a cross-sectional view of the valve chamber portion of the valve unit illustrated in FIG. 13 at a valve opening degree of approximately 90 degrees (fully open).

FIG. 22 is a diagram illustrating a configuration of a valve system according to another aspect of the present invention.

FIG. 23 is a diagram illustrating a configuration of a valve system according to another aspect of the present invention.

FIG. 24 is a flowchart for explaining an operation flow of the valve system of the aspect illustrated in FIG. 23.

FIG. 25 is a diagram illustrating a configuration of a valve system according to another aspect of the present invention.

FIG. 26 is a diagram illustrating a configuration of a valve system according to another aspect of the present invention.

FIG. 27 is a diagram for explaining a configuration of a database of a server provided in the valve system of the aspect illustrated in FIG. 26.

FIG. 28(a) is a block diagram illustrating a configuration of an estimation unit of the information processing system provided in the valve system of the aspect illustrated in FIG. 26, and FIG. 28(b) is a flowchart of when an estimation process is executed.

FIG. 29(a) is a schematic view of a machine learning unit by a convolutional neural network illustrating an example of machine learning for obtaining an output of diagnosis estimation information, and FIG. 29(b) is a flowchart of processing by the convolutional neural network.

FIG. 30(a) is a schematic view of a database illustrating an example of a mounting information transfer technique for generating a new domain from existing domains stored in the database, and FIG. 30(b) is an explanatory view illustrating another example of a data structure of the present invention.

### DESCRIPTION OF EMBODIMENTS

### First Embodiment

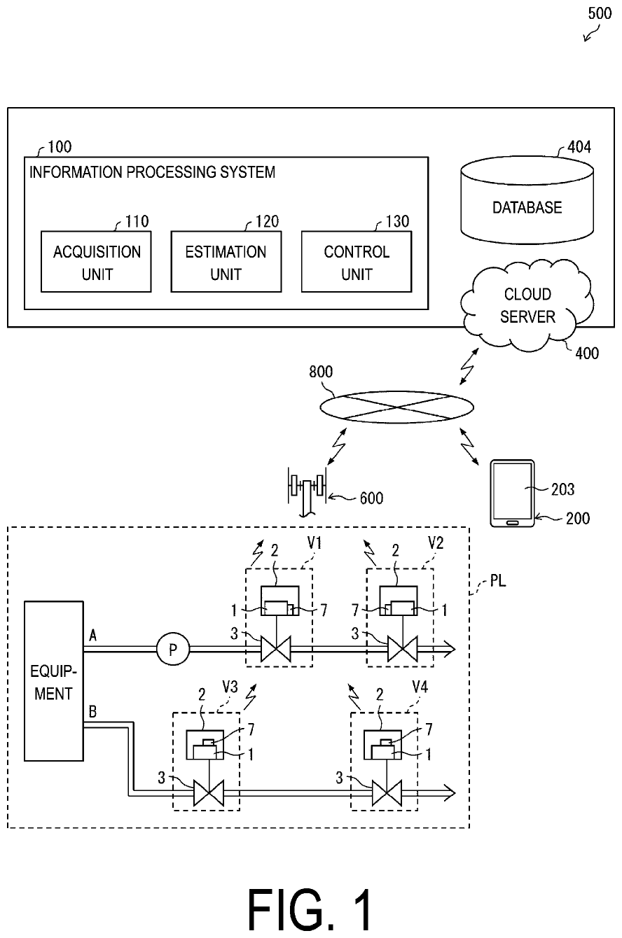

Hereinafter, an embodiment of the present invention will be described in detail with reference to FIG. 1 to FIG. 21.

FIG. 1 is a diagram schematically illustrating a valve system 500 according to the present embodiment. The valve system 500 includes piping facility PL, a gateway 600 capable of wirelessly communicating with respective sensor units 1 of valve units V1, V2, V3, V4 included in the piping facility PL, a server 400 communicably connected to the gateway 600 via a network (Internet 800) communicably connected to the gateway 600, and a display device 200.

Here, the server 400 may be a cloud server, and stores an information processing system 100, a database 404, and the like.

As illustrated in FIG. 1, the piping facility PL includes a device used for a heat source, chemical refining, water purification, or purification, for example, piping systems A, B connected to this device, the valve units V1, V2, V3, V4 provided to the piping systems A, B, and a pump P. Each of the valve units V1 to V4 includes a valve 3, an actuator 2 that drives the valve 3, and the sensor unit 1. The sensor unit 1 includes a gyro sensor 7. Details of the piping facility PL will be described below.

The valve system 500 includes the information processing system 100 in order to monitor and control this piping facility PL. Hereinafter, the information processing system 100 will be described.

### Configuration of Information Processing System 100

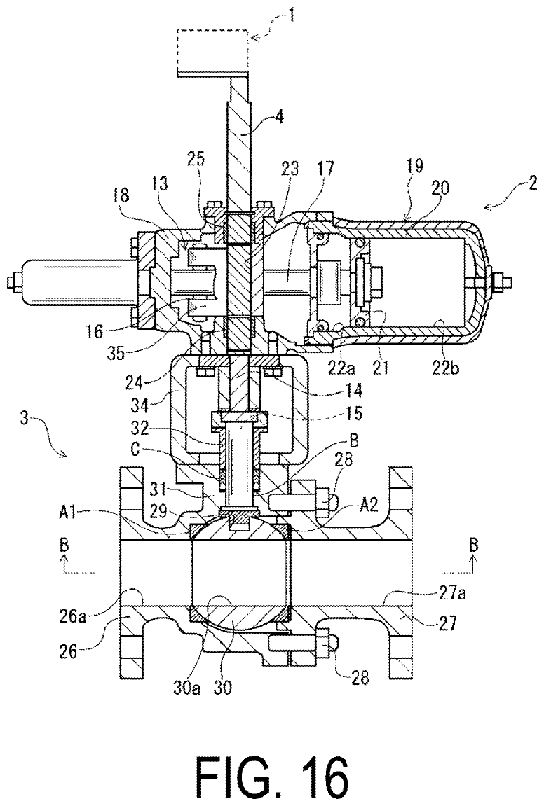

The information processing system 100 monitors and controls the valves 3 and the actuators 2 of the piping facility PL to maintain the valve units V1 to V4. Therefore, as illustrated in FIG. 1, the information processing system 100 includes an acquisition unit 110, an estimation unit 120, and a control unit 130. Specifically, the information processing system 100 includes the acquisition unit 110 configured to acquire angular velocity data of a rotation of a rotating shaft, the angular velocity data being detected by the gyro sensor 7, in the valve 3 in which the rotating shaft is rotated by the actuator 2 to rotate a valve body of a valve. The information processing system 100 includes the estimation unit 120 configured to estimate a degree of abnormality of each of the actuator 2 and the valve 3 by referring to the angular velocity data acquired by the acquisition unit 110. Here, the “rotating shaft” is a general term for a shaft that transmits power for rotating the valve body, and refers to one or more of a stem 15 (FIG. 16) coupled to the valve body (ball 30 in FIG. 16) of the valve 3 of each of the valve units V1 to V4, an output shaft 14 (FIG. 16) of the actuator 2 coupled to the stem 15, and a control shaft 4 (FIG. 16) of the actuator 2. Detailed configurations of the valve 3 and the actuator 2 will be described below.

### Acquisition Unit 110

The acquisition unit 110 acquires the value of the angular velocity detected by the gyro sensor 7 of the sensor unit 1 of each valve unit of the piping facility PL as angular velocity data. The acquisition unit 110 acquires such data from the sensor unit 1 via the gateway 600 and the server 400. The angular velocity data is also stored in the database 404 via the server 400.

The acquisition unit 110 may acquire the value of the angular velocity detected by the gyro sensor 7 as the angular velocity data, or may acquire angular velocity data (angular velocity graph) obtained by transitioning the measured value of the angular velocity in accordance with the valve opening degree on the sensor unit 1 side.

### Estimation Unit 120

The present inventors discovered that a decrease in performance of the valve 3 due to, for example, wear or chipping of a ball seat and a decrease in performance of the actuator 2 are largely related to a change in angular velocity with respect to the valve opening degree over time. This led to a new finding that the degree of abnormality of each of the actuator 2 and the valve 3 can be estimated by primarily measuring the change in the angular velocity with respect to the valve opening degree over time by the gyro sensor 7 of the sensor unit 1 and diagnosing the change.

Thus, the estimation unit 120 estimates the degree of abnormality of each of the actuator 2 and the valve 3 on the basis of a value of the angular velocity data corresponding to the opening degree of the valve.

Specifically, in the case of an aspect in which the actuator 2 is a pneumatic rotary actuator having a double-acting scotch yoke structure and the rotating shaft is rotated by this scotch yoke pneumatic actuator, the present inventors discovered the following. That is, when the scotch yoke has deteriorated in the case described above, the output torque is weakened when the valve is in an intermediate opening degree, and a change is observed in the transition of the angular velocity data at the intermediate opening degree. That is, it was discovered that, when the scotch yoke has deteriorated, the transition of the angular velocity data when the valve is in an intermediate opening degree changes (decreases) as compared with an actuator without scotch yoke deterioration. Similarly, in the case of a rack-and-pinion actuator, it was discovered that there is a change (decrease) in the transition of the angular velocity data when the valve is in an intermediate opening degree due to the deterioration.

In particular, the interior of the pneumatic actuator is likely to be corroded by “moisture contained in the air” supplied thereto and by moisture caused by “condensation due to a temperature difference between the air having a relatively high temperature supplied to the interior of the actuator and the atmosphere in the actuator” in the actuator. Among these, in the case of the “moisture contained in the supplied air” being the cause, corrosion occurs on an inner wall portion of a cylinder or on a surface of a piston where the supplied air stagnates. As a result, when the piston slides on the inner wall portion in association with the operation of the actuator, both the surface of the inner wall portion and the surface of the piston are roughened by the rust caused by the corrosion. Then, a sliding resistance between the piston and the inner wall of the pneumatic actuator during operation when air is supplied to the actuator increases. At this time, the pressure itself of the supplied air, which is the output torque of the actuator, does not change. Accordingly, the value of the angular velocity, which is the open/close velocity of the valve, decreases. Thus, by detecting the change in the transition of the angular velocity, it is possible to identify the deteriorated state caused by rust in the interior of the pneumatic actuator.

Furthermore, the present inventors noted that when the valve 3 is a ball valve, in particular, there is substantially no contact between the ball valve body and the ball seat at an intermediate opening degree of the valve 3. That is, it was considered unlikely that the ball valve would affect the transition of the angular velocity data at an intermediate opening degree. In other words, the present inventors discovered that, when a rapid change (decrease) is observed in the transition of the angular velocity data at an intermediate opening degree of the valve 3, it can be determined (estimated) that an operation abnormality of the scotch yoke actuator has occurred.

Thus, the estimation unit 120 estimates the degree of abnormality of the actuator 2 on the basis of the numerical value of the angular velocity data in a rotation of the rotating shaft other than the rotation during the initial stage and the final stage (at an intermediate opening degree of the valve).

The present inventors noted that when the piping facility PL illustrated in FIG. 1 is installed outdoors, there are cases in which the actuator 2 is affected by the external environment and fails. Specifically, it was discovered that, when the actuator 2 itself has deteriorated due to the influence of rainwater or the like, the output torque of the actuator decreases and the angular velocity exhibited in the “transition of the angular velocity at an intermediate opening degree of the valve operated by the deteriorated actuator” is lower than the angular velocity exhibited in the “transition of the angular velocity at an intermediate opening degree of the valve operated by a normal actuator” in some cases. As described above, when the valve is in an intermediate opening degree, there is substantially no contact between the ball valve body and the ball seat, making it unlikely that the valve will affect the transition of the angular velocity data at an intermediate angle. Therefore, when an overall change (decrease) is observed in the transition of the angular velocity data when the valve is in an intermediate opening degree, it can be determined (estimated) that the actuator has deteriorated.

On the other hand, during a period other than when the valve is in an intermediate opening degree, that is, a period when the valve starts the open operation from a fully closed state and a period when the valve starts the close operation from a fully open state (initial stage of rotation of valve body), the ball valve body and the ball seat are in contact with each other Similarly, during the periods immediately before the valve is fully closed and immediately before the valve is fully open (end stage of rotation of the valve body), the ball valve body and the ball seat are in contact with each other. That is, during these periods, the state of the valve, particularly the ball seat, is represented as angular velocity data via the rotating shaft.

Thus, the estimation unit 120 estimates the degree of abnormality of the valve 3 on the basis of the numerical value of the angular velocity data in the initial stage of rotation and the end stage of rotation of the rotating shaft.

That is, in the present embodiment, the degrees of abnormality of both the actuator 2 and the valve 3 are estimated by the estimation unit 120 on the basis of the transition of the angular velocity data from the initial stage of rotation, through an intermediate stage of rotation, and to the end stage of rotation of the rotating shaft.

Herein, an “abnormality” of the valve includes foreign matter intrusion into the ball seat, ball seat swelling, ball seat wear, packing wear, wear of a gland portion of the body, gland packing wear, stem bearing wear, stem galling, foreign matter adhesion or accumulation on the ball surface, ball surface scratches, and the like, as described below. An “abnormality” of the actuator includes an increase in sliding resistance of the actuator (including an increase in sliding resistance due to rust or corrosion caused by moisture entering the actuator), failure due to the freezing of moisture in the actuator, a decrease in supply pressure, and the like, as described below.

“Estimating the degrees of abnormality” includes not only state monitoring for determining whether an abnormality has occurred but also failure prediction and lifetime diagnosis. In other words, a prediction can be made as to how much time will elapse until the actuator or the valve is likely to fail, that is, a failure period prediction can be made. This means that a replacement period prediction can be made.

To thus estimate the degrees of abnormality, the estimation unit 120 estimates the degrees of abnormality by referring to comparative angular velocity data acquired by detecting a rotation of a rotating shaft of a normal valve by a gyro sensor, and comparing the angular velocity data acquired by the acquisition unit 110 with the comparative angular velocity data, for example. The comparative angular velocity data is stored in the database 404, and may be acquired by the estimation unit 120 directly from the database 404, or may be acquired from the database 404 via the acquisition unit 110. As described below, the comparative angular velocity data may be stored in advance or may be obtained by accumulating past angular velocity data detected by the gyro sensor 7.

The angular velocity data acquired by the acquisition unit 110 and the comparative angular velocity data are compared by the estimation unit 120 across the entire valve opening degree range (valve opening degrees between 0° and 90°). However, the comparison is not limited thereto, and may be performed within a specific valve opening degree range that is a portion of the entire range. An example of a specific valve opening degree range is a valve intermediate opening degree. As described above, at an intermediate opening degree of the valve 3, by comparing actually measured angular velocity data with the comparative angular velocity data, it is possible to estimate the degree of abnormality with a focus on the actuator 2. As another example of a specific valve opening degree range, an initial opening degree, a final opening degree, or the respective periods before the initial opening degree may be used.

Here, the gyro sensor 7 of the sensor unit 1 is preferably attached to the control shaft 4 (FIG. 16) or the output shaft 14 of the actuator 2. This is because, when there is looseness (play) in a connection portion between the output shaft of the actuator 2 and the stem of the valve 3, a time lag occurs between the time when the actuator 2 starts driving and the time when the valve 3 starts rotating. Accordingly, when the gyro sensor 7 is attached not to the valve 3 side but to the actuator 2 side, the angular velocity can be detected simultaneously with the start of driving by the actuator 2, making it possible to detect the angular velocity more precisely.

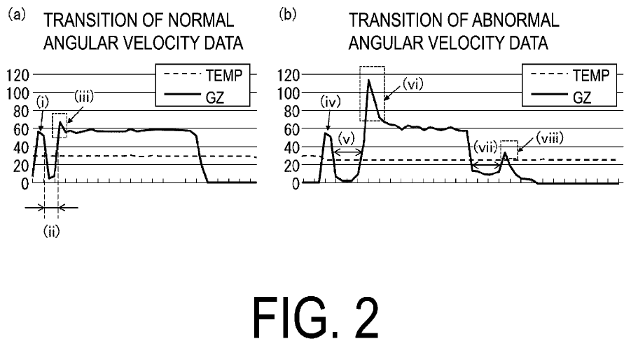

FIG. 2 shows a comparison between a graph of the angular velocity data acquired by the acquisition unit 110 and a graph of the comparative angular velocity data. FIG. 2 illustrates an aspect in which a gyro sensor is attached to an output shaft of a pneumatic rotary actuator having a double-acting scotch yoke structure in a ball valve type valve unit in which a ball valve is rotated by rotation of the rotating shaft by the actuator. (a) in FIG. 2 is a graph of the comparative angular velocity data. On the other hand, (b) in FIG. 2 is a graph of the angular velocity data acquired by the acquisition unit 110, and illustrates an aspect in which an abnormality has occurred in the valve 3.

From the time lag relationship described above, it can be determined that the angular velocity data within the ranges before a first peak (i) in the transition of the angular velocity data shown in (a) in FIG. 2 and before a first peak (iv) in the transition of the angular velocity data shown in (b) in FIG. 2 represent the angular velocity of only the actuator. That is, before the initial stage of rotation of the ball valve (valve body), there is a period in which, although the actuator is driving, the ball valve is not yet rotating due to the play. A “play” means one or both of backlash of a mechanism that rotates the valve body of the actuator (for example, a drive system reduction gear inside the actuator 2) and looseness in the connection portion between the output shaft of the actuator and the stem of the valve. With this “play” present, typically (even in a normal valve unit), a time lag caused by play occurs between the time when the actuator 2 starts driving and the time when the valve 3 starts rotating. When this time lag is defined as a power non-transmission region, the degree of abnormality of the actuator can be estimated on the basis of the angular velocity data acquired in this power non-transmission region.

Here, (b) in FIG. 2 shows a valve unit in which the actuator 2 is normal, but an abnormality of foreign matter intrusion in the ball seat of the valve 3 has occurred. Therefore, in the case of (a) in FIG. 2, which is normal, the transition in the portion indicated by (ii) occurs, while in (b) in FIG. 2, a decrease in angular velocity occurs, as in the transition in the portion indicated by (v). Similarly, in (b) in FIG. 2, a peak (viii) occurs and a decrease in angular velocity indicated by (vii) occurs. (vii) indicates a state in which the angular velocity temporarily decreases. For example, (vii) indicates a state in which the rotation of the ball valve stops due to foreign matter intrusion. The peak (viii) is a peak indicating a state in which the angular velocity data temporarily increases due to the release of force accumulated as the result of the foreign matter intrusion after (vii). For example, (viii) indicates a temporary rise in angular velocity due to a specific position of the ball valve passing over the intrusion position. The angular velocity subsequently decreases towards the final opening degree of the valve. The estimation unit 120 compares the graph of the angular velocity data acquired by the acquisition unit 110 with the graph of the comparative angular velocity data, thereby identifying the presence of a difference between the angular velocity data at the initial stage of rotation and the end stage of rotation of the ball valve (valve body). Then, on the basis of this identification, the estimation unit 120 estimates (identifies) that the valve 3 is operating abnormally.

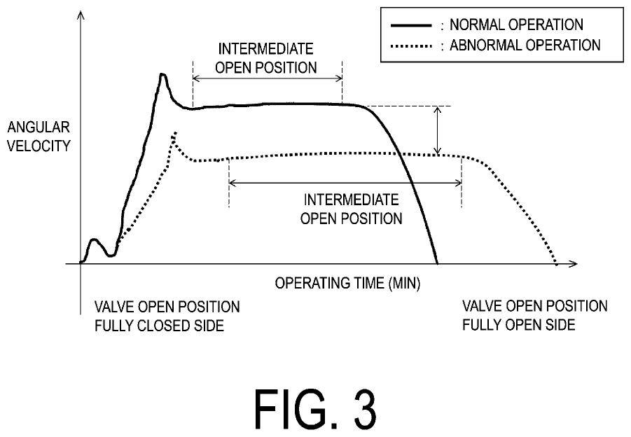

FIG. 3 is a graph showing a comparison of angular velocity graphs based on a different valve unit, plotting the angular velocity data in accordance with the valve opening degree. The graph combines a graph of the angular velocity data acquired by the acquisition unit 110 (dashed line) and a graph of the comparative angular velocity data (solid line). The estimation unit 120 compares the shape and the pattern of the graph of the angular velocity data acquired by the acquisition unit 110 with the shape and the pattern of the graph of the comparative angular velocity data. Then, the estimation unit 120 identifies that the angular velocity data acquired by the acquisition unit 110 changes (decreases) as a whole at an intermediate opening degree of the valve (that is, a period other than the initial stage of rotation and the end stage of rotation of the valve body). This allows the estimation unit 120 to estimate (identify) that the actuator 2 is operating abnormally.

In the graph of the angular velocity data acquired by the acquisition unit 110 (dashed line) illustrated in FIG. 3, the operation time for one operation from the start of operation of the actuator 2 to the fully opening degree of the valve 3 is long compared with that in the graph of the comparative angular velocity data (solid line). The estimation unit 120 can estimate (identify) an abnormality on the basis of this operation time for one operation. In FIG. 3, this phenomenon of the lengthening of the operation time is observed, and the angular velocity data acquired by the acquisition unit 110 at an intermediate opening degree of the valve has a lower angular velocity. The estimation unit 120 then, on the basis of these features, estimates (identifies) that the operation of the actuator 2 is slow. In this case, conceivably a malfunction has occurred due to water entering the actuator 2. In a case in which the phenomenon of the lengthening of the operation time for one operation is observed and the load is increased, it can be presumed that there is an abnormality in the valve 3.

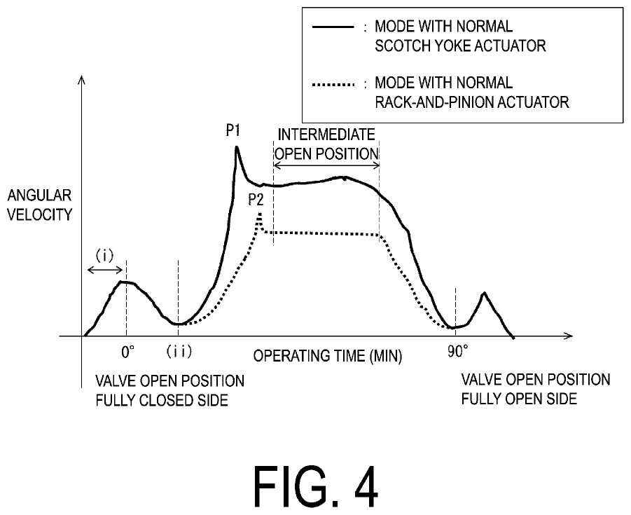

FIG. 4 shows an angular velocity graph using yet another valve unit. In FIG. 4, the angular velocity graph indicated by a solid line represents a valve unit including a normal scotch yoke actuator, and the angular velocity graph indicated by a dashed line represents a normal rack-and-pinion actuator. As in the cases of FIG. 2 and FIG. 3, immediately after operation of each actuator, there is a period (i) in which the valve body does not rotate due to the play in the connection portion between the actuator and the valve. The angular velocity decreases from the time when the valve opening degree is 0° to the time when the valve body of the valve 3 starts to move as indicated by (ii) of FIG. 4. Subsequently, the valve and the actuator operate together in any aspect and exhibit a maximum angular velocity (peaks P1, P2). Next, in the aspect with the scotch yoke actuator indicated by the solid line, there is significant fluctuation in the angular velocity at the intermediate opening degree, forming a mountain-like shape. On the other hand, in the aspect with the rack-and-pinion actuator indicated by the dashed line, there is little fluctuation in the angular velocity at the intermediate opening degree, making the graph relatively flat. In FIG. 4, after the valve opening degree exceeds 90°, the angular velocity may rise in reaction.

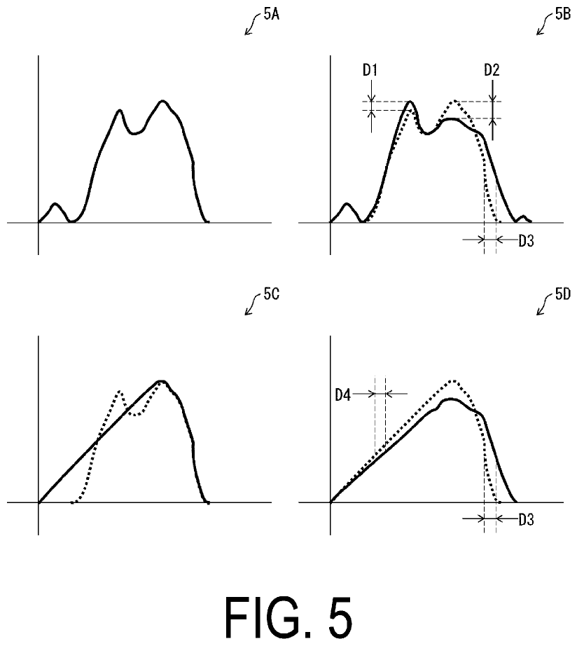

The following is a more detailed explanation of how an angular velocity graph measured on the basis of a valve unit having an abnormality exemplified below changes compared with the angular velocity graph of the normal valve unit shown in FIG. 4. In the following example, the angular velocity of the output shaft 14 of the actuator 2 is observed using the gyro sensor 7. FIG. 5 is a diagram illustrating an example of graphs of angular velocity data of a valve unit and an actuator in a normal state and in an abnormal state in a scotch yoke valve unit used in the information processing system according to an embodiment of the present invention. In FIG. 5, a graph 5A is a graph showing an example of the angular velocity data of the valve unit in the normal state, and a graph 5B is a graph showing an example of the angular velocity data of the valve unit in the abnormal state. In FIG. 5, a graph 5C is a graph showing an example of the angular velocity data of a normal actuator, and a graph 5D is a graph showing an example of the angular velocity data of an abnormal actuator. The dashed lines in graphs 5B, 5C, and 5D indicate the angular velocity of the valve unit in the normal state (graph 5A). The alternate long and short dashed line in graph 5D indicates the angular velocity of the normal actuator (graph 5C). The vertical axis of each graph in FIG. 5 indicates the angular velocity, and the horizontal axis indicates the valve opening degree and the operation time.

As shown in graph 5A and graph 5C, in the combination of the scotch yoke pneumatic actuator and the ball valve, in particular, at the intermediate opening degree of the valve where the contact and sliding surface of the ball seat and the ball of the ball valve is minimized, the influence of the actuator on the angular velocity data is greater compared with the influence of the ball or the ball seat. That is, in the angular velocity graph, peaks having a protruding shape appear in the intermediate opening degree portion. This is conceivably because the angular velocity in the intermediate opening degree portion temporarily increases, increasing the change in angular velocity.

On the other hand, when rust occurs inside the scotch yoke pneumatic actuator and the angular velocity of the scotch yoke pneumatic actuator decreases, the change in angular velocity becomes gentle, as shown in graph 5B and graph 5D. Therefore, as indicated by D1 and D2 in the drawing, the above-described peaks having a protruding shape in the intermediate opening degree portion are reduced or eliminated. When expressed by a shape in the angular velocity graph, the peak shape at the intermediate opening degree is a more gentle shape. The occurrence of an abnormality in the actuator can be determined by this change in angular velocity at the intermediate opening degree. Furthermore, an increase in sliding resistance due to the rust described above tends to reduce the output of the pneumatic actuator and extend the open/close time of the valve. A small peak at the end of the operation time in graph 5B indicates a decrease in angular velocity due to the foreign matter intrusion and an increase in angular velocity due to the force accumulated thereby, as described with reference to FIG. 2.

In a case in which, in addition to the rust described above, the ball seat of the ball valve is worn in the scotch yoke pneumatic actuator, the sliding resistance between the ball seat and the ball decreases. Therefore, the influence of the angular velocity of the actuator on the rotation speed of the ball further increases. Accordingly, as shown in D3 and D4 in the drawing, the change in angular velocity tends to be gentle not only at the final stage of rotation but also at the initial stage. Thus, abnormalities in a valve such as a ball valve in which the area of the sliding portion changes as the ball rotates are likely to appear at least in the initial state or the final stage of rotation. In contrast, abnormalities in the scotch yoke pneumatic actuator are likely to appear at an intermediate opening degree, a discovery first made by the present inventors.

In the failure pattern above, an intermediate opening degree is, for example, within a range from 10° to 80° in the case of a quarter-turn valve having a maximum opening degree of 90°. Among the intermediate opening degrees, the angular velocity data particularly within the opening degree range of 50° to 80° is suitable for finding an abnormality in the scotch yoke pneumatic actuator.

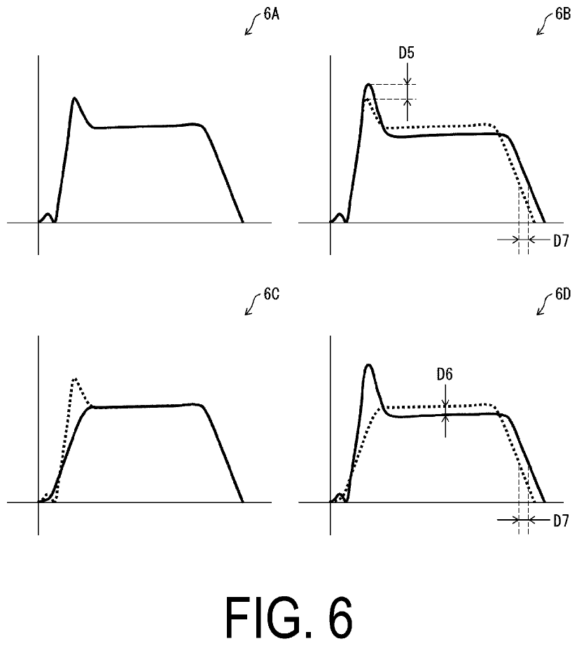

FIG. 6 is a diagram illustrating an example of graphs of angular velocity data of a valve unit and an actuator in a normal state and an abnormal state in a rack-and-pinion valve unit used in the information processing system according to an embodiment of the present invention. In FIG. 6, a graph 6A is a graph showing an example of the angular velocity data of the valve unit in the normal state, and a graph 6B is a graph showing an example of the angular velocity data of the valve unit in the abnormal state. In FIG. 6, a graph 6C is a graph showing an example of the angular velocity data of a normal actuator, and a graph 6D is a graph showing an example of the angular velocity data of an abnormal actuator. The dashed lines in graphs 6B, 6C, and 6D indicate the angular velocity of the valve unit in the normal state (graph 6A). The vertical axis of each graph in FIG. 6 indicates the angular velocity, and the horizontal axis indicates the valve opening degree and the operation time. In the rack-and-pinion valve unit, an abnormality is considered detected on the basis of the following.

In a combination of a rack-and-pinion pneumatic actuator and a ball valve, rust due to corrosion occurs in each meshing portion (for example, each gear) of the rack and the pinion, roughening a surface of each meshing portion. As a result, the sliding resistance at the meshing of the individual teeth increases, and the output of the pneumatic actuator decreases. Accordingly, as indicated by D5 and D6 in the drawing, the detected angular velocity data decreases. As the angular velocity decreases, the open/close time of the valve lengths, as indicated by D7 of the drawing. Thus, abnormalities are detected at an intermediate opening degree and thereafter.

In addition, in the case of a spring return actuator capable of returning to an original starting position by an elastic deformation action of an internal spring, an elastic deformation force is reduced when the spring is corroded. For example, when a diameter of the spring is reduced (diameter is narrowed) as the spring rusts, the stress from the spring may not be transmitted to the piston, or the spring may break and the opened/closed valve may not return to its origin.

### Example of Abnormality [1]: Foreign Matter Intrusion in Ball Seat

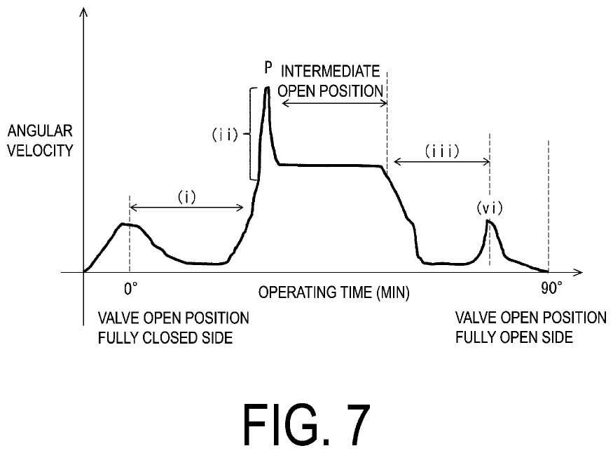

FIG. 7 is a graph showing the transition in angular velocity indicated by the valve unit when foreign matter gets caught in the ball seat of the valve 3. Foreign matter intrusion in the ball seat includes material contained in a fluid.

In the angular velocity graph of FIG. 7, because the foreign matter is caught in the ball seat, the friction between the valve body and the ball seat increases, lengthening the time from the valve opening degree of 0° until the valve body of the valve 3 starts to move ((i) in FIG. 7). The valve body snags on the ball seat and the angular velocity rises significantly at the moment the valve body is unsnagged. On the other hand, at an intermediate opening degree, there is substantially no contact between the valve body and the ball seat, and thus no abnormality appears in the angular velocity. When the valve opening degree approaches 90°, the valve body and the ball seat start to come into contact with each other again. From that point in time, the valve body and the ball seat snag each other, requiring time until the valve is fully closed ((iii) in FIG. 7). Then, a rise in angular velocity is observed in reaction to the unsnagging ((vi) in FIG. 7). In this case example, the series of valve operations from the fully open state to the fully closed state is longer than that of a normal valve.

### Example of Abnormality [2]: Ball Seat Swelling

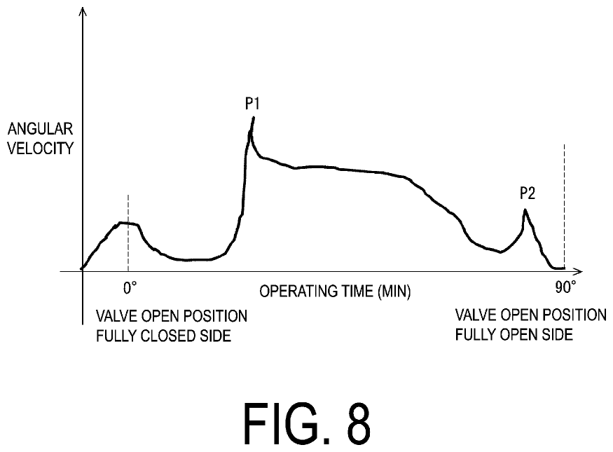

The ball seat may swell when exposed for a long period of time to a solvent of a fluid or the like. FIG. 8 is a graph showing the transition in angular velocity indicated by the valve unit when the ball seat of the valve 3 swells.

In the angular velocity graph of FIG. 8 as well, as in the angular velocity graph of FIG. 7, because the frictional resistance of the ball seat with respect to the valve body is high, the series of valve operations from the fully open state to the fully closed state becomes longer than that of a normal valve.

As shown in the angular velocity graph of FIG. 8, in the vicinity of the fully closed state and the fully open state, a sudden increase in the angular velocity may occur when the valve body is snagged by the ball seat and released therefrom (P1, P2 in FIG. 8).

### Example of Abnormality [3]: Play Abnormality

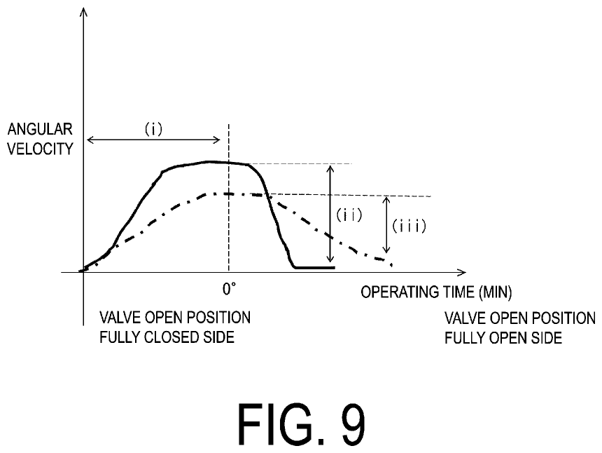

As described above, there is play between the output shaft 14 and the stem 15. The output shaft 14 and the stem 15 collide every time the valve opens and closes. Therefore, at least one of the output shaft 14 and the stem 15 may chip, wear, or deform by torsion. When the play described above increases due to such deformation, a change in angular velocity also occurs. The angular velocity graph of FIG. 9 is an angular velocity graph of a first peak portion from when the actuator starts to operate until the valve body of the valve rotates.

The angular velocity graph indicated by the solid line in FIG. 9 is an angular velocity graph of a valve unit in which an abnormality of increased play has occurred. When the play becomes significant, the time required up to the first peak lengthens ((i) in FIG. 9), and a feature of a steep gradient of deceleration indicated by (ii) in FIG. 9 appears on the graph. In a rack-and-pinion actuator that uses gears, backlash between the gears is also considered as play. Therefore, when the operation time from the start of operation of the actuator to the start of rotation of the valve body (first peak) is defined as a power non-transmission region, the power non-transmission region is determined by, for example, backlash due to contacting surfaces between the gears and a gap due to the play between the output shaft 14 and the stem 15. Then, the power non-transmission region tends to change in a direction in which the operation time lengthens or in a direction in which the peak of angular velocity decreases due to an increase in backlash caused by wear of the contacting surfaces between the gears or an increase in the gap caused by the play between the output shaft 14 and the stem 15. Detecting this change in the power non-transmission region can more suitably identify the state of the rack-and-pinion actuator that uses gears.

### Example of Abnormality [4]: Actuator Abnormality

As described above, abnormalities of the actuator can be monitored in the angular velocity graph at the first peak portion from when the actuator starts to operate to when the valve body of the valve rotates. Therefore, for example, as in the angular velocity graph indicated by the alternate long and short dashed line in FIG. 9, when the time required up to the first peak lengthens ((i) in FIG. 9) or the value of the angular velocity at the peak lowers ((iii) in FIG. 9), the determination can be made that an abnormality has occurred in the actuator. Abnormalities of the actuator in this case includes an increase in sliding resistance of the actuator, failure due to freezing of moisture in the actuator, a decrease in air supply pressure, and the like.

Specifically, in the angular velocity graph of the first peak portion from when the actuator starts to operate to when the valve body of the valve rotates, the peak is large and the transition of the angular velocity is shifted rearward with respect to operation time. Furthermore, in a case in which the phenomenon of the lengthening of the operation time for one operation occurs, an increase in the resistance of the actuator 2 can be presumed (identified). In a case in which the angular velocity data is no longer detected after the lengthening of the operation time for one operation, an increase in sliding resistance due to the accumulation of moisture inside the actuator 2 and the freezing thereof, or due to the occurrence of rust or corrosion, and as a result, operation failure can be presumed (identified). In a case in which the rotation of the valve 3 is slow even though the data indicating the driving of the actuator 2 is substantially constant, a decrease in the supply pressure of air to the actuator can be presumed (identified).

### Example of Abnormality [5]: Wear of Ball Seat and Gland Portion of Body

For example, when an abnormality of the wearing of the ball seat occurs, the maximum angular velocity is high and the angular velocity is high (torque is low) as a whole, and thus the time per rotation from valve fully open to fully closed is shorter than that of a standard reference (not illustrated).

Similarly, in a case in which the gland portion of the body becomes loose, the angular velocity increases and the torque decreases. The frictional force between the ball seat and the valve body is reduced, making the time per rotation from valve fully open to fully closed shorter than the standard reference (not illustrated).

With regard to findings related to the angular velocity data of valves, reference can be made to the contents of the aforementioned Patent Document 2. Further, with regard to estimation processing related to valve abnormalities, the method described in Patent Document 2 can be adopted.

The estimation unit 120 or the database 404 may store the angular velocity graphs of the various abnormality types described above together with the angular velocity graph of the normal valve unit. After the actually measured angular velocity graph is acquired, one or both of the angular velocity graph of the normal valve unit and the angular velocity graphs of the various abnormality types described above may be used as the comparative angular velocity data.

The embodiment of the present invention is not limited to the comparison of graphs. For example, the acquisition unit 110 may acquire a numerical value of the angular velocity data detected at a specific valve opening degree (for example, a valve intermediate opening degree) from the angular velocity data detected by the gyro sensor 7, and the estimation unit 120 may compare the numerical value with that of comparative angular velocity data to estimate the degree of abnormality. In this case, the “numerical value of the angular velocity data” acquired by the acquisition unit 110 is not limited to the numerical value itself of the angular velocity detected by the gyro sensor 7. That is, as will be described below, the value may be data of a representative value representing a behavior of a certain rotating shaft based on a plurality of angular velocity data detected by the gyro sensor 7 that detects the angular velocity data of the certain rotating shaft. In this case, the representative value based on the comparative angular velocity data is also stored in the database 404, similarly to the comparative angular velocity data.

The database 404 may store not only the comparative angular velocity data and the graph thereof but also a threshold value. For example, the estimation unit 120 acquires a threshold value together with the comparative angular velocity data and, when the angular velocity data acquired by the acquisition unit 110 exceeds the threshold value, can determine that an abnormality has occurred.

The estimation unit 120 can find a difference between the angular velocity data acquired by the acquisition unit 110 and the comparative angular velocity data (or threshold value). This can diagnose the degree of the abnormality that has occurred. The estimation unit 120 can perform failure prediction and lifetime diagnosis by reading the transition (change) in this difference on the basis of the angular velocity data acquired over time from a certain gyro sensor 7.

The estimation unit 120 may divide one angular velocity graph (series of angular velocity data) corresponding to the entire range of the valve opening degree into an intermediate valve opening degree and other valve opening degrees, estimate the degree of abnormality of the actuator 2 from the intermediate valve opening degree, and estimate the degree of abnormality of the valve 3 from the other valve opening degrees. However, the present invention is not limited thereto, and the estimation unit 120 can simultaneously estimate (identify) the degree of abnormality of the valve 3 and the degree of abnormality of the actuator 2 from one angular velocity graph (series of angular velocity data) corresponding to the entire valve opening degree range.

Herein, the acquisition unit 110 acquires angular velocity data of each of the rotating shafts of a group of valve units V1 to V4. Therefore, the estimation unit 120 can estimate the degrees of abnormality of both the valves 3 and the actuators 2 by comparing the angular velocity data of the valves 3 of the valve units V1 to V4 with the comparative angular velocity data.

In another aspect, for each piping system of the piping systems A and B or for a specific piping system, the estimation unit 120 may comprehensively estimate the degree of abnormality of the valves and the actuators of a group of valve units attached to the piping system. For example, the estimation unit 120 can estimate that the degree of abnormality of the piping system A is larger than that of the piping system B. This can take measures related to maintenance work, such as prioritizing the replacement of the valves of the piping system A, as described below.

Without being limited to each piping system, it is possible to collectively perform the estimation processing of the degree of abnormality for a plurality of valve units (for example, the valve unit V2 and the valve unit V4) having the same degree of load in the piping facility PL on the basis of the mounting information indicating the load applied to the valve units as described below.

The estimation unit 120 can have various functions. Examples of the functions include each type of function required in a process (flow including various processing steps) of performing symptom diagnosis such as failure prediction of the components of the valve 3 and the actuator 2, optional functions such as a power saving function and a data calibration function based on an auxiliary sensor (acceleration sensor or the like), or a function executed by a predetermined application acquired from an external device.

### Control Unit 130

The control unit 130 controls at least the acquisition unit 110 and the estimation unit 120, and performs an output process or a display process of a result, a warning, or the like on the basis of the estimation result of the estimation unit 120.

The control unit 130 determines the maintenance work for one or both of the valve 3 and the actuator 2 on the basis of the degrees of abnormality estimated by the estimation unit 120. As an example, in a case in which the estimation unit 120 outputs an estimation result corresponding to the angular velocity data of a group of valves acquired by the acquisition unit 110, the control unit 130 determines collective maintenance work. For example, the control unit 130 determines collective maintenance work in which the maintenance work of the individual valves 3 and actuators 2 is collectively performed for one or both of the group of valves 3 and the group of actuators 2 on the basis of the estimation result of the estimation unit 120 corresponding to the angular velocity data of the group of valves acquired by the acquisition unit 110. That is, the control unit 130 corresponds to a specific example of the “determination unit” in the claims.

The control unit 130 can transmit the angular velocity data to an external portable terminal (not illustrated).

### Server 400

The server 400 uses a cloud server. The cloud server is suitable for various computation processing and security measures described below. The server 400 includes a database described below. Furthermore, the server may include a predetermined application server for terminal display or the like. In this case, a user having a terminal can access the server anytime and anywhere to view a valve state.

The database 404 stored in the server 400 includes:
(1) a unique information accumulation function of the actuator 2 and the valve 3,
(2) an accumulation function of the measurement data of the angular velocity data and the air pressure of the actuator 2, and
(3) an operation torque calculation function of the actuator 2.

(1) The unique information accumulation function of the actuator 2 and the valve 3 stores drawing information as well as design information of the actuator 2 used for calculating the operation torque.

(2) The accumulation function of the measurement data of the angular velocity data and the air pressure of the actuator 2 accumulates such measurement data in series when received multiple times from a portable terminal.

(3) The operation torque calculation function of the actuator 2 calculates the operation torque from the cylinder diameter of the actuator 2 (not illustrated), an offset amount from the central axis of the pinion (or scotch yoke), the conversion efficiency, and the like on the basis of the air pressure data received from a portable terminal, for example.

The server 400 has a communication function based on a middle-range wireless communication module such as long-term evolution (LTE) or Wi-Fi (trade name) as a transmission/reception function with the gateway 600.

### Operation of Information Processing System 100 (Information Processing Method)

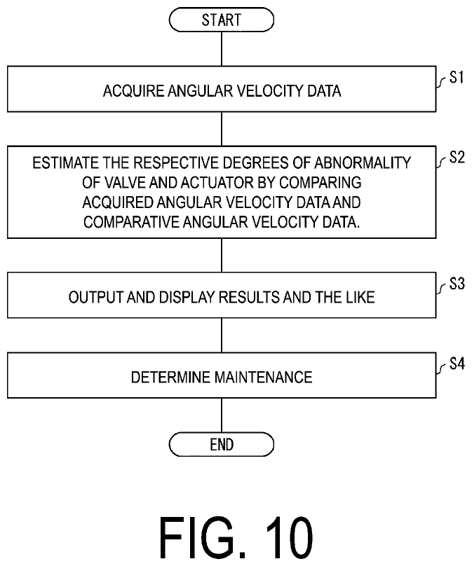

FIG. 10 is a flowchart illustrating an operation flow of the information processing system 100. The operation of the information processing system 100 will be described with reference to FIG. 10.

In step S1, the acquisition unit 110 acquires the angular velocity data acquired by the gyro sensor 7 detecting the angular velocity data of the rotating shaft (acquisition process).

Subsequently, in step S2, the estimation unit 120 performs a process of comparing the shape and the pattern of the graph of the comparative angular velocity data with the shape and the pattern of the graph of the angular velocity data acquired by the acquisition unit 110 in step S1, as described above. In this process, the estimation unit 120 estimates the degree of abnormality of each of the valve 3 and the actuator 2 (estimation process). The estimation result of the estimation unit 120 is acquired by the control unit 130.

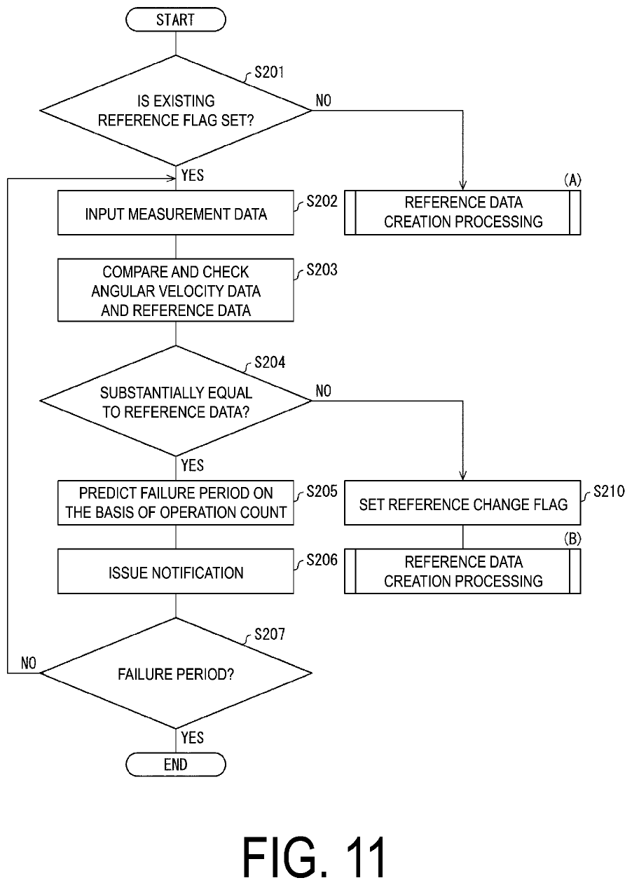

The processing flow of step S2 will now be described in detail with reference to FIG. 11. FIG. 11 is a diagram illustrating the processing flow of the estimation processing.

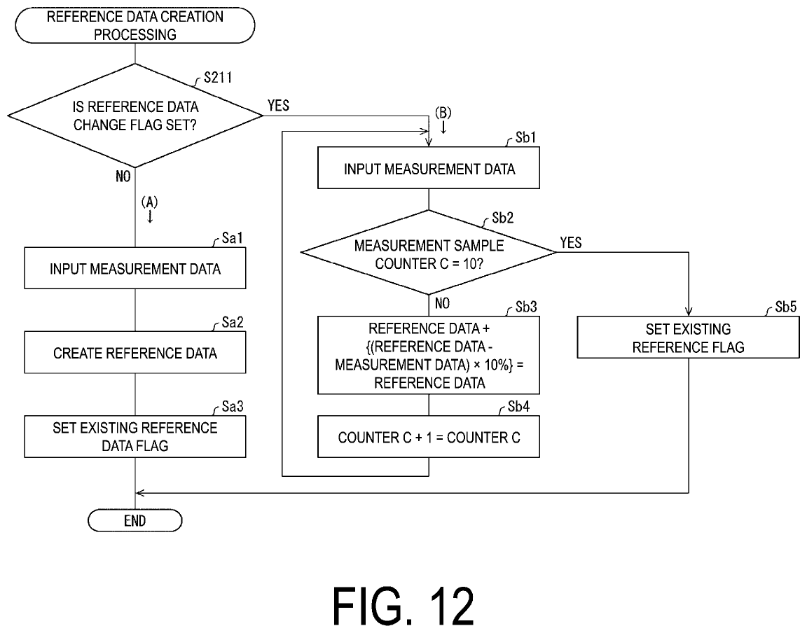

When this processing flow is first executed, the processing step S201 in FIG. 11 is a process of determining, for the acquired angular velocity data, whether a table matching the product data included in this angular velocity data is present in the database 404. In FIG. 11, for each piece of product data, whether a reference data table of comparative angular velocity data (reference data) is present is managed in advance with an existing reference flag. Thus, with this flag, the determination is made whether a table (same product data) to be retrieved is present. If such a table is present, the process proceeds to processing step S202. If such a table is not present, the process proceeds to processing step (A) in FIG. 12.

Processing step S202 of FIG. 11 is a process of inputting the measurement data to the database 404.

Next, in processing step S203 of FIG. 11, the measurement data input to the database 404 is received, and a table record having the same number of openings and closings as the number of openings and closings included in the measurement data is retrieved to acquire the reference data.

Next, in processing step S204 of FIG. 11, the determination is made as to whether the output data (angular velocity graph pattern) of this reference data and the output data included in the measurement data are substantially equal. In processing step S204, the process proceeds to processing step S205 if it is determined that the two are substantially equal, and to processing step (B) of FIG. 12 if it is determined that the two are not substantially equal. The method of comparing the two pieces of output data (technique of determining whether the two are substantially equal) can be selected as appropriate from various known techniques (such as the concept of distance between data, and similarity in set and shape).

The processing step S205 in FIG. 11 is a processing step in which failure period prediction based on the operation count is performed. Specifically, usage frequency data (count/period) and the number of failure openings and closings (count) included in the product data of the reference data are acquired. On the other hand, the number of current openings and closings (count) included in the measurement data is also acquired. From these, a predicted failure period of the valve and the actuator of the valve unit for which the measurement data was measured can be acquired as (the number of failure openings and closings—the number of current openings and closings)/usage frequency (period). This can specifically acquire the predicted failure period merely by simple processing without intervention of statistical processing (machine learning) having a large processing cost.

In this processing flow, the determination result may be acquired by referring to a determination result table (not illustrated), for example. This determination result table is created in advance for each of the same product data in accordance with the number of openings and closings. For example, records with notification details (for example, normal, warning, or failure), failure notice period (for example, notification three months in advance or notification one month in advance), and the like set as column names are prepared in order of magnitude with the number of openings and closings of a valve as a main key. Then, with reference, through an appropriate method, to a determination result table record having the same number of openings and closings as the number of openings and closings included in the measurement data, each piece of data such as the notification details and the failure notice period may be acquired as the determination result. The notification details and the like may be partitioned by a plurality of predetermined threshold values. In this manner, the predicted failure period may be acquired by table reference without the intervention of computation processing.

In processing step S205 of FIG. 11, a failure notice period is acquired. In processing step S206 of FIG. 11, the notification details are acquired. These can be transmitted to the terminal for display via appropriate means.

In processing step S207 of FIG. 11, whether the period is the failure period is determined. Whether the period is the failure period is determined by adopting a predetermined threshold value as a boundary, for example. In a case in which it is determined in this processing step S207 that the period is the failure period, the process proceeds to processing step S208. If not so, the process may return to processing step S202 to continue abnormality diagnosis.

On the other hand, in FIG. 11, in a case in which a reference data table matching the product data is not present, a process of newly creating a second reference data table is performed on the occasion of this abnormality diagnosis. This processing is processing step (A) illustrated in FIG. 12, and this processing step (A) includes processing steps Sa1 to Sa3. As will be described below, whether the process proceeds to processing step (B), which is a process for changing the second reference data table, is managed by a reference data change flag (processing step S210 in FIG. 11), and thus a determination is first made with regard to the reference data change flag in processing step S211.

That is, even when the valves are the same but are significantly different in terms of the data in the 90-degree interval from fully closed to fully open and a trend continues in which the degree of this difference is substantially similar for a plurality of valves, for example, there is a limit to the reference data based on tests performed within the company. In a case in which data acquisition based on the number of products after sales is overwhelmingly large, it is assumed the data itself is degraded. It is also assumed that product data capable of identifying product attributes and specifications, such as a special fluid used or external temperature and humidity having an excessively wide range, does not match the output data even if existent as reference data. It is also assumed that product data of ball valves manufactured by another company does not exist in the first place, in other words, reference data is not stored at all. To solve a variable factor that causes degradation in prediction from the perspective of failure prediction control, there are two reference data creation processing steps (A) and (B) in the present embodiment (FIG. 12). Processing step (A) is referred to as a new reference data creation mode, processing step (B) is referred to as a reference data changing mode, and the entire process illustrated in FIG. 12 is referred to as reference data creation processing.

In FIG. 12, processing step (A) is a process of newly storing, in the database 404, second reference data created from the measurement data. For example, a case in which a test is performed on a product of the company before product shipment will be described. First, as measurement data, product data is manually input or automatically input from a known optical reading sensor or the like. Subsequently, the ball valve is rotated and controlled by the actuator 2 attached to the valve 3 and, as output data, the average usage frequency of the valve, approximately assumed, and the angular velocity data for each angle per rotation from fully closed to fully open, from the new product to failure based on testing, are input. Such a series of tests is performed N times to capture highly accurate measurement data. Then, a second reference data table is completed in the subsequent processing step Sa2. Then, in the following processing step Sa3, an existing reference data flag indicating reference data is newly present is SET and the processing ends, returning the flow to the determination details flow.

Next, a case will be described in which, for example, a ball valve of a product manufactured by another company is measured in the process of newly creating second reference data. The second reference data table includes a record indicating a ball valve manufactured by another company. According to this, at the stage in which the sensor unit 1 is mounted and the product data is read, it is recognized that the product is not manufactured by the company, but by another company. Accordingly, in processing step (A), the series of measurements is not carried out N times as described above, but reference data is created with one measurement (processing step Sb3), and the flow returns to the flow illustrated in FIG. 11.

On the other hand, in a case in which the product has the same product data and thus an existing second reference data table is present, but this reference data table does not have substantially equal reference data (processing step S204), this requires replacement of the second reference data itself. In this case, the reference data change flag is SET (step S210 to step S211), and processing step (B) is executed. In this case, since the existing reference data is present, a process of changing the data in small increments is adopted.

In processing step (B), when output data is acquired from the measurement data (processing step Sb1), a difference between this output data and the existing second reference data is found, the existing second reference data is increased or decreased by 10% of this difference, and the new data set as new second reference data. In processing steps Sb1 to Sb4, a counter C is set to 1, angular velocity data is input as output data and subjected to similar processing repeatedly ten times, the process then exits the loop in processing step Sb2, the existing reference flag is SET in processing step Sb5, and the processing ends.

In this way, leveling is performed with the measurement data at least ten times, and thus the second reference data is not replaced with measurement data unique to only one ball valve. In particular, a sudden change in specifications of a ball seat of a ball valve manufactured by another manufacturer is unlikely to be input as product data. Thus, it is quite effective, in view of accuracy, to compare and check not only the product data but also the measurement data, in particular, angular velocity data.

Furthermore, as another means for reference data replacement, there is a method of weighting such as weighted averaging (weighting by the degree of difference in a feature portion). For example, in a case in which a valve manufactured by another company is the target, when the specification of the ball seat is suddenly changed for some technical reason and the ball seat is switched to another ball seat, since each ball seat has a unique angular velocity, the same valves have a large fluctuation width with respect to the existing reference data large in most of the open/close intervals from fully closed to fully open. In such a case, when a similar tendency continuously appears in a plurality of valves, the product data is weighted and the reference data is replaced in small increments with a fluctuation ratio smaller than the fluctuation width. For example, if the output data fluctuates by 10% from the previous reference data, the output data is replaced in small increments at a time with a fluctuation ratio of 2%. This can create reference data from the output data (measurement data) even if the reference data is not stored in advance. As a result, the failure prediction system can be easily implemented and the prediction accuracy can be improved.

In this way, when reference data (comparative angular velocity data) is created, a process of newly creating and applying reference data and a process of replacing the existing reference data while leveling or weighting the reference data are combined. As a result, the reference data of the product can be created before product shipment, reference data can be automatically created by inputting measurement data of a product manufactured by another company on the market, or various situations such as a sudden change in component usage on the market can be addressed.

Thus, with the sensor unit 1 used for valve 3 in use, it is possible to perform the process of creating second reference data including the output data and the product data corresponding to the number of openings and closings of the valve 3, with the measurement data measured by this sensor unit 1. This second reference data creation process includes, as illustrated in FIG. 12, a new reference data creation mode and a reference data change mode.

Returning to the processing flow of FIG. 4, in the subsequent step S3, the control unit 130 performs a process of outputting and displaying a warning or the like when the period is determined to be the failure period on the basis of the estimation result in step S2. In step S3, a process of issuing a warning is performed, and then whether there is failure is determined. When it is determined that there is no failure, the process may return to step S2 (processing step S202 in FIG. 11) to continue abnormality diagnosis.

Subsequently, in step S4, the control unit 130 determines the maintenance work for one or both of the valve 3 and the actuator 2 on the basis of the estimation result in steps S2 (determination process). As an example, in step S5, the control unit 130 determines collective maintenance work in which the maintenance work of the individual valves and actuators is collectively performed in one or both of a group of valves and a group of actuators on the basis of the estimation result of the estimation unit 120 in step S3 corresponding to the angular velocity data of the group of valves 3 acquired by the acquisition unit 110 in step S1.

According to the information processing system 100 described above, state identification and failure prediction (lifetime diagnosis) of an actuator that frequently fails due to being installed outdoors are possible. By using the same angular velocity data, valve state identification and failure prediction (lifetime diagnosis) are also possible.

In the present embodiment, an angular velocity graph is acquired from the measured angular velocity data, and various diagnostic processes including a lifetime prediction process are executed on the basis of a shape/pattern analysis of this graphed data. This diagnostic process includes, for example, a process of recognizing and evaluating the graph pattern, a process of calling existing accumulated data (comparative graph data) and comparing the data with the acquired graph pattern, a process of determining symptoms, and a process of outputting and displaying the result, a warning, and the like. Then, a physical or logical system is configured so that such various processes can be appropriately executed.

Furthermore, the information processing system 100 may have a function of measuring and retaining various unique data, such as fluid pressure, viscosity and temperature, temperature and humidity of a product environment, number of openings and closings of the valve and operation time after installation, actuator supply pressure and activation speed; or, in a ball valve, materials and wear coefficients of the ball seat and the packing in the ball valve, and the sizes of the ball and the flow path; a function of externally outputting and displaying these data; a function of using these in the process described above, and the like.

As described above, according to the present embodiment, the degrees of abnormality of the actuator 2 and the valve 3 are estimated by associating the structure specific to the object (valve 3 and actuator 2) to which the sensor unit 1 is attached with the position, magnitude, or peak width of a plurality of peaks appearing in the angular velocity data or the appropriately graphed angular velocity data, and precisely identifying the state and precisely making a diagnosis on the basis of the identified content.

Furthermore, according to the present embodiment, by using such a two-dimensional angular velocity graph image, it is possible to not only estimate the state of the valve but also identify failure and the state and predict failure by a technique such as described below. Specifically, by recognizing the angular velocity graph as an image and subjecting the image to machine learning, it is possible to utilize the angular velocity graph for failure prediction of the valve and the actuator on the basis of the state changes of the valve and the actuator.

Thus, in addition to a pass/fail determination based on a comparison or a threshold value, such as a peak angular velocity value or a time indicated by a peak value, an image is further used for failure prediction. Accordingly, it is possible to confirm the state of the valve including a state such as wear or loss of the seat (ball seat, rubber seat) and a state of the actuator on the basis of an overall trend, without being affected by an instantaneous change in a value. As a result, it is also possible to predict an appropriate maintenance period in accordance with the situation. Moreover, by accumulating and updating these as teaching data used for machine learning, it is possible to improve the prediction accuracy of the maintenance period. If actually measured data (image) is lacking compared with the data (image) accumulated in advance, it is possible to identify that an abnormality has occurred in one or both of the valve and the actuator.

### Comparative Angular Velocity Data

As described above, as the comparative angular velocity data, there exists:
(1) comparative angular velocity data stored in advance in the server 400, the angular velocity data being acquired when the angular velocity sensor detects the rotation of the rotating shaft (any one of the output shaft, the control shaft, and the stem of the valve of the actuator) of a normal valve unit, and
(2) comparative angular velocity data created by angular velocity data actually measured from the valve units V1 to V4 provided in the piping facility PL. The comparative angular velocity data of (2) can be created from angular velocity data acquired from the valve units in a state in which an abnormality cannot yet occur at a relatively early time after installation of the valve units V1 to V4.

However, the present invention is not limited thereto, and the comparative angular velocity data may be, for example:
(3) comparative angular velocity data variable by machine learning. The machine learning of (3) will be described in an embodiment described below.

### Display Device 200

The operation states of the valve 3 and the actuator 2 can be visually recognized by using the display device 200 (for example, a portable terminal) via a communication module 10 provided with Bluetooth (trade name). With the use of Bluetooth (trade name) or the like, even when the valve 3 and the actuator 2 are installed in a complex pipe line or a narrow place, a check can be made by the portable terminal from a nearby location without direct visual recognition thereof.

In a case in which an initial setting mode function is incorporated in advance, when an initial setting operation is performed on the portable terminal immediately after installation of the sensor unit 1, it is only necessary to reset to the state of the initial setting mode as appropriate in accordance with the usage mode of the sensor unit 1. In this case, for example, data such as angle data is set to an initial value in accordance with the fully closed state of the valve 3. At this time as well, no adjustment work is required on the actuator 2 and the valve 3 side, and product information or an order number retained in an IC tag 12, for example, can be utilized to configure settings. Further, for example, as long as the application software for portable terminals is downloaded from a download URL and initial setting data is transmitted to the server, an installation date of the sensor unit 1 can be recorded.

After completion of the initial setting work, the initial setting mode is switched to normal mode. At the time of switching to normal mode, the power supply may be turned off after a certain period of time has elapsed to make a transition to a power saving mode.

As the display device 200 described above, a smart phone or a tablet (not illustrated) is used, for example. In this case, functions related to the input of data include, for example:
(1) a function of receiving data and unique information from the sensor unit 1 and the information processing system 100,
(2) a function of transmitting the data and the unique information received from the sensor unit 1 and the information processing system 100 to a server (not illustrated), and
(3) a function of retaining global positioning system (GPS) position information, camera images, and the like and transferring such information to a server.

On the other hand, functions related to data outputs using the display device 200 include, for example:
(1) a function of displaying the information received from the server 400 or the information processing system 100, and
(2) a function of displaying information such as estimation content (abnormality report) related to the degree of abnormality estimated by the estimation unit 120.

Although not illustrated, in (1) the function of displaying the information received from the information processing system 100 or the server 400, information including at least diagnostic results of the valve and the actuator can be displayed in an easily viewable form. For example, the angular velocity data corresponding to the measured number of openings and closings of the valve is displayed on a graph together with the comparison target data within a range from fully open to fully closed (from fully closed to fully open), and the determination result thereof is displayed. The actuation count, operation time, pressure data, and actuation torque history, pressure and temperature of the fluid, and environmental temperature and humidity of the actuator 2 can be displayed. Furthermore, it is possible to display the respective drawings and the like of the actuator 2 and the valve 3.

As another function, maintenance recommendation information useful for maintenance work may be displayed. Alternatively, when an erroneous input is suspected in the initial setting of the sensor unit 1 or the target product to which the sensor unit 1 is attached is an imitation, such information may be displayed. Examples include a case in which the actuation time of the actuator 2 is extremely early or late for the model and order number (special specifications different for each order) of the actuator 2 and the valve 3, and a case in which the on-site actuator 2 captured by a camera of the portable terminal is small.

On the other hand, as (2) the function of displaying information such as an abnormality report, for example, when the actuation time is extremely long or when the value of the gyro sensor 7 is unchanged even though an air pressure is applied, that is, when the actuator 2 is not activated, the determined is made that an abnormality has occurred and is displayed as a preliminary report.

### Gateway 600

The gateway 600 is communicably connected to the sensor unit 1, the display device 200, or the server 400, and has a function of managing and controlling these, and the like. The gateway 600 is communicably connected to an access point (not illustrated) and can be connected to the sensor unit 1 or the display device 200 communicable with this access point. For example, the gateway 600 acquires information such as angular velocity information (angular velocity data) of a valve V measured by the sensor unit 1, and transmits the information to the server 400 or the display device 200. The gateway 600 acquires information from the database 404 and transmits the information to the display device 200. Furthermore, the access point may be a wireless device capable of connecting the sensor unit 1 or the display device 200 to an external network of the system such as the Internet 800, and a router function may be provided separately.

### Piping Facility PL

As illustrated in FIG. 1, the sensor unit 1 equipped with the gyro sensor 7 is attached to each of the valve units V1, V2, V3, V4 included in the piping facility PL.

### Sensor Unit 1

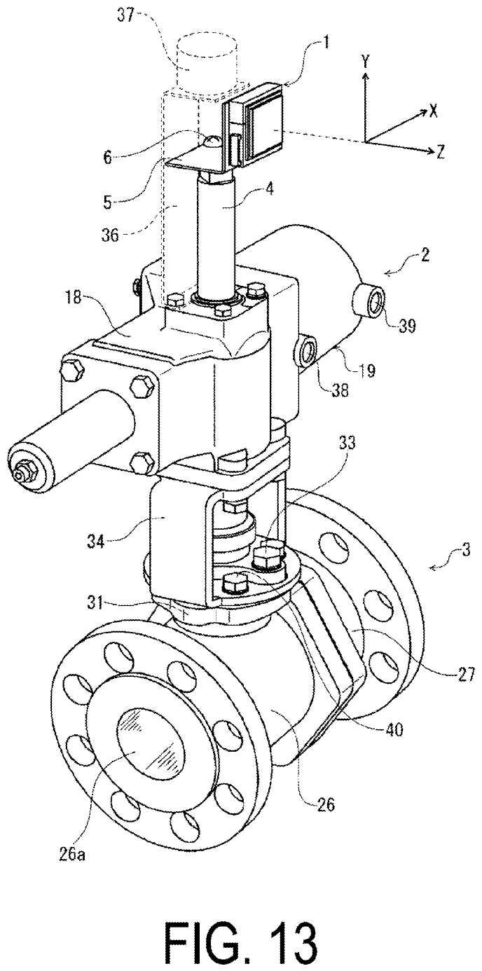

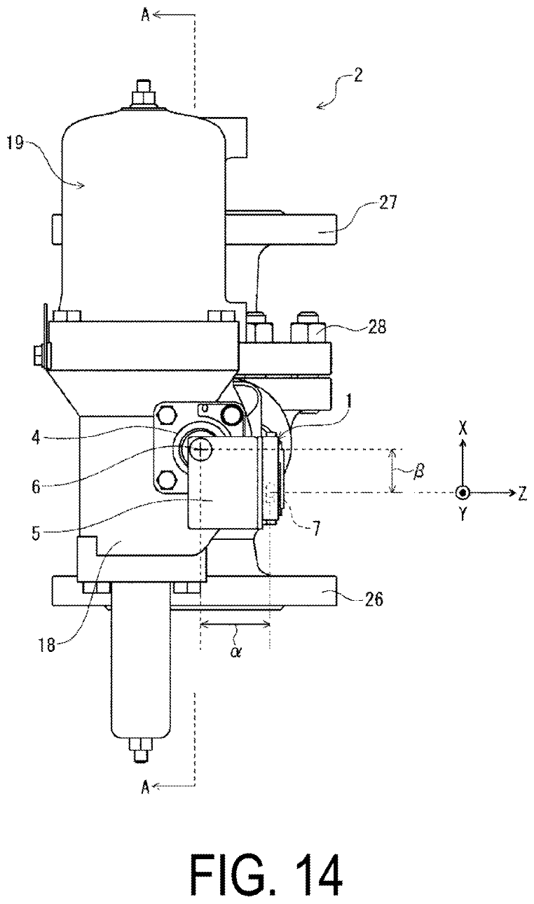

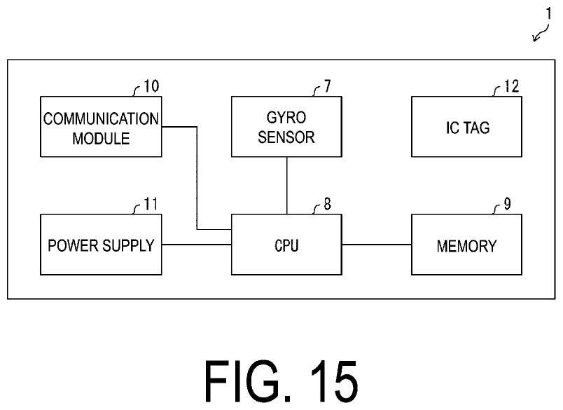

FIG. 13 is an external perspective view of the valve unit in a state in which the sensor unit 1 is attached to the actuator 2. In FIG. 13, the valve 3 of the valve unit is in a fully open state, the X axis coincides with a flow path axial center direction, the Y axis is in a direction in which the control shaft 4 extends relative to this X axis (upward direction in the drawing), and the Z axis is a right-turn direction on the X and Y axes. FIG. 14 is an external plan view of the actuator 2 in FIG. 13 as viewed from above. FIG. 15 is a block diagram illustrating the constituent elements of the sensor unit 1.

The sensor unit 1 has a compact size and weight to the extent of being easily carried with one hand. In one example, the sensor unit 1 is formed in a rectangular plate shape having lengths of approximately 15 cm×10 cm and a thickness of approximately 3 cm. The sensor unit 1 has a weight of about several hundred grams as a finished product and, for example, displays product information, a product number, and an attachment direction (method of use) on a front surface side, and is provided with a predetermined attachment portion formed of a female screw hole, a bonding surface, or the like (not illustrated) on a back surface side, allowing attachment of fitting 5 thereto. Alternatively, for example, the sensor unit 1 may be formed in a circular disk shape of about the same size.

The fitting 5 is an example of an attachment means and, in one example, is composed of an L-shaped metal plate, fixed to the back surface side of the sensor unit 1 on one side surface serving as an attachment surface, and fixed to an upper end portion of the control shaft 4 of the actuator 2 on the other side surface with a bolt 6. Here, the NAMUR standard is a standard interface standard (VDI/VDE 3845-2010) for actuators and defines dimensions for valve attachment and for accessory attachment on an upper portion of an actuator. If the actuator 2 complies with this NAMUR standard, a female screw portion (not illustrated) complying with this standard is provided at the upper end portion of the control shaft 4. Accordingly, the sensor unit 1 can be easily retrofitted to the actuator 2 via the fitting 5 by utilizing this female screw portion. Here, in an actuator already being used, an accessory such as an open/close limit switch may be attached to an upper portion of the control shaft 4. In this case, by using the L-shaped metal plate, it is possible to attach the sensor unit 1 to the control shaft 4 while securing a space in the upper portion of the control shaft 4 with the accessory attached thereto.

The gyro sensor 7 is a rectangular semiconductor element provided on an internal substrate so as to be parallel to the short sides and the long sides of the sensor unit 1 having a rectangular shape. Specifically, in FIG. 13 and FIG. 14, the sensor unit 1 is attached in a posture parallel to the XY plane and, in this state, the yaw axis of the gyro sensor 7 coincides with the Z-axis direction, and the roll axis and the pitch axis coincide with the Y-axis and the X-axis directions, respectively.

The gyro sensor 7 is provided so as to be doubly eccentric with respect to the position of control shaft 4 at a reference position where the valve 3 is in a fully open state. Specifically, the sensor unit 1 is arranged at a position away from the axial center position of the control shaft 4 (in an axial center direction of flow paths 26a, 27a) by an eccentric distance α (rightward direction in the drawing), in parallel thereto, with the fitting 5 interposed therebetween, and is arranged at a position away from an axial center position of the bolt 6 (in the vertical direction to the axial center of the flow paths 26a, 27a) by an eccentric distance β (downward direction in the drawing) in accordance with the position of the gyro sensor 7 on the substrate. In one specific example, α equals 18 mm and β equals 33 mm.

With the gyro sensor 7 arranged at such a doubly eccentric position, at least, when the sensor unit 1 is attached, a vacant space where no other members are present can be utilized with ease. Furthermore, with the gyro sensor 7 thus arranged, the sensor unit 1 can be easily attached in a compact manner, can be easily retrofitted on-site to products of various sizes, structures, and postures, offers favorable rough-attachment workability in particular. and expands the range of installation targets. While the position of the sensor unit 1 is kept close in distance to the position of the control shaft 4, a large rotation radius (α2+β2)^{1/2} from the control shaft 4, which is a rotating shaft to be measured, can be ensured. The arrangement of the gyro sensor 7 is not limited to the structure via the fitting 5, and the gyro sensor 7 may be fixed at an intermediate position of the control shaft 4 in the axial direction by a fitting fixed in a form of nipping the control shaft 4.

In the present embodiment, an example in which the sensor unit 1 is attached to the control shaft 4 is illustrated in FIG. 13 and FIG. 14, but the sensor unit 1 may be attached to the output shaft 14 via an appropriate attachment means. Alternatively, attachment may be made to the stem 15 via an appropriate attachment means. As described above, as long as the sensor unit 1 is attached to the output shaft 14 or the control shaft 4, the sensor unit 1 can acquire the angular velocity data of only the actuator during the period from the operation start time of the actuator to when the valve body (ball 30) starts to rotate and can estimate the degree of abnormality of the actuator. Therefore, the sensor unit 1 is preferably attached to the output shaft 14 or the control shaft 4.

The gyro sensor 7 detects rotation of the rotating shaft (the control shaft 4, the output shaft 14, and the stem 15) as angular velocity data. In the present embodiment, state monitoring, diagnosis, and lifetime prediction of the valve 3 and the actuator 2 are performed on the basis of the angular velocity data of the rotating shaft.

The gyro sensor 7 is a vibration-type gyro sensor that uses integrated circuit (IC) type micro electric mechanical system (MEMS) technology, is a semiconductor type, and is included in the inner substrate. Specifically, the gyro sensor is a triaxial gyro sensor capable of measuring rotation in three orthogonal XYZ axial directions, and one incorporated in various general consumer products is currently used. More specifically, the product L3GD20 manufactured by STMicroelectronics N.V. is used, and features thereof include, for example: power supply voltage: DC 3.3 V (operating range: DC 2.4 V to DC 3.6 V); current consumption: 6.1 mA; and measurement range: ±250 dps (resolution: 0.00875 dps), ±500 dps (resolution: 0.0175 dps), and ±2000 ps (resolution: 0.07 dps). However, these features are not restrictive and of course can be selected and adjusted as desired in accordance with the implementation.

As illustrated in FIG. 15, the sensor unit 1 includes, in addition to the gyro sensor 7 described above, a central processing unit (CPU) 8, a memory 9, the communication module 10, a power supply 11, and the IC tag 12.

The CPU 8 means also including cache, can use one having a common specification, can be selected as desired in accordance with the implementation, and, in particular, needs to have the processing capacity which can implement each function described below (in particular, a power-saving function). The CPU 8 is connected to peripheral elements such as the memory 9 and the communication module 10 via a bus.

The memory 9 is selected as desired in accordance with the implementation, provided that it has the capability (capacity or speed) to implement each function described below, However, when continuous power supply is not assumed, a nonvolatile memory is preferred. Furthermore, a capacity large enough to sufficiently read various applications that perform the power-saving function and the like is suitable.

The communication module 10 may be the short-range wireless communication module of Bluetooth (trade name), or may be a medium-range wireless communication module such as long-term evolution (LTE) or Wi-Fi (trade name). The data accumulated in the memory 9 is transmitted to the information processing system 100 via the communication module 10 in response to a request from the information processing system 100, and is acquired by the acquisition unit 110. A aspect may be adopted in which the data accumulated in the memory 9 is transmitted to a portable terminal via the short-range wireless communication module, allowing state records of the actuator 2 and the valve 3 to be displayed and checked using this portable terminal.

The power supply 11 includes a predetermined power supply conversion circuit and is selected as desired in accordance with the implementation. For example, the power supply 11 is an independent power supply based on a button battery, or a battery power supply. For example, in the case of a button battery, an attachment/detachment position thereof is a hole portion in which a battery lid having a disk shape is formed in a lid body with a seal member (not illustrated) interposed therebetween, and the button battery is engaged with and fixed in the hole portion and attachably/detachably provided by rotation of the lid at a predetermined angle by a flathead screwdriver or the like. The power supply 11 has connected thereto each element including the gyro sensor 7, the CPU 8, the memory 9, and the communication module 10, and serves as a driving source for these. The power supply 11 may be provided with a battery power supply and a solar cell. In this case, the battery power supply can serve as a driving source of the gyro sensor 7, and the solar cell can serve as a driving source of a second sensor 700 described below, for example. In addition to the battery power supply, a capacitor may be installed.

In the IC tag 12, information unique to the actuator 2 and the valve 3 is accumulated. This information includes at least (1) the model types or order numbers of the actuator 2 and the valve 3, and (2) a URL for downloading application software. The accumulated information is input from a dedicated terminal or other means (not illustrated). The URL for downloading the application software is for portable terminals. From this URL for downloading, application software can be acquired.

In addition, the sensor unit 1 may combine a temperature sensor, an acceleration sensor, a magnetic sensor, and the like (not illustrated). To save power, a piezoelectric sensor may be combined to activate the gyro sensor 7 when necessary. An aspect of activating the gyro sensor 7 when necessary will be described in another embodiment.

In the sensor unit 1 described above, the angular velocity data output from the gyro sensor 7 is accumulated in the memory 9 through data processing in the CPU 8. In the CPU 8, the angular velocity data output from the gyro sensor 7 may be converted into a data format displayable as a graph on an external monitor. With regard to data accumulation from the CPU 8 to the memory 9, the data may be set so as to accumulate in the memory 9 after at least simple data processing, such as so-called thinning in which the data is accumulated in the memory 9 from the CPU 8 at regular intervals, data averaging, or predetermined filtering (noise removal).

In the present embodiment, an aspect in which the angular velocity is detected by the gyro sensor 7 is exemplified, but the present invention is not limited thereto, and another angular velocity sensor may be used as long as the angular velocity can be detected.

### Actuator 2

FIG. 16 is a cross-sectional view taken along line A-A in FIG. 14. In the present embodiment, an actuator of a pneumatic rotary type having a double-acting scotch yoke structure is adopted as the actuator 2.

As illustrated in FIG. 16, the actuator 2 is provided with a conversion mechanism 13 that converts reciprocating motion into rotational motion inside the main body, and a rotational force of this conversion mechanism 13 can be output to the stem 15 of the ball valve 3 by the output shaft 14. The conversion mechanism 13 has a structure in which a scotch yoke 35 for transmission to the rotating shaft and a pair of pin rollers 16 engaging with the scotch yoke 35 are provided on a piston rod 17, and these are incorporated in a housing 18.

A cylinder portion 19 is fixed to one side of the housing 18, that is, the right side in FIG. 16, and a piston 21 integrated with the piston rod 17 is accommodated in a cylinder case 20 of this cylinder portion 19. The cylinder case 20 may be coated with a material such as polytetrafluoroethylene (PTFE), electroless nickel plating (ENP), or hard chromium plating (Hcr), for example. The example herein is of a double-acting type in which air intake/exhaust ports 38, 39 are provided in the cylinder portion 19, and the piston 21 reciprocates in accordance with the intake/exhaust of compressed air to and from air chambers 22a, 22b via the air intake/exhaust ports 38, 39. As a result, the piston rod 17 linearly reciprocates, and this motion is transmitted to the scotch yoke 35 via the pin rollers 16 and converted into a rotating motion.

In the scotch yoke 35, a rotating shaft is insertably provided via a fastener 23 interfittably provided by means of a spline or the like (not illustrated), and the rotation of the rotating shaft is transmitted to the scotch yoke 35 via the fastener 23. The rotating shaft is formed of the output shaft 14 on the ball valve 3 side (lower side in FIG. 16) and the control shaft 4 on the opposite side (upper side in FIG. 16), and both the output shaft 14 and the control shaft 4 are attached to the housing 18 via cylindrical members 24, 25. In the cylindrical members 24, 25, a predetermined bearing is press-fitted inside a metal shaft bearing (not illustrated), and these cylindrical members 24, 25 are each press-fitted into a bearing portion formed in the housing 18. Then, the output shaft 14 and the control shaft 4 are inserted inside. In this way, the rotating shaft is rotatably attached to the main body of the actuator 2.

A pressure sensor (not illustrated) can be provided to the actuator 2 as appropriate in accordance with the implementation. In this case, for example, a speed controller (not illustrated) is provided to the air intake/exhaust ports 38, 39, and the pressure sensor is connected between the air intake/exhaust ports 38, 39 and the speed controller via a coupling such as a T-tube or nipple tube. Then, the pressure sensor is attached to a branching portion of the T-pipe. This allows pressure measurement by a pressure sensor to be made with a simple structure without adversely affecting the intake/exhaust of compressed air.

In the present embodiment, an example in which a pneumatic actuator is used as an actuator for automatic operation has been described. In the case of a pneumatic actuator, the actuator is driven by receiving a supply of air, and thus does not require a power source, resulting in the advantage that the valve system of the present invention can be installed even in a large-scale plant where power source installation is difficult. However, other than a pneumatic actuator, the actuator may be a hydraulic actuator or an electric actuator.

### Valve 3

In the present embodiment, the valve 3 is a rotary valve that opens and closes a flow path by rotating a rotating shaft. The rotating shaft is not limited to that of an automatic valve, and may be a rotating shaft formed of a stem of a manual valve via a manual handle (not illustrated). In the present embodiment, the valve 3 is the ball valve 3 of a quarter-turn type. However, in addition to such a valve, various rotary valves including motor-driven types such as a plug valve, a butterfly valve, or a ball valve of a 180-degree rotating type may be used.

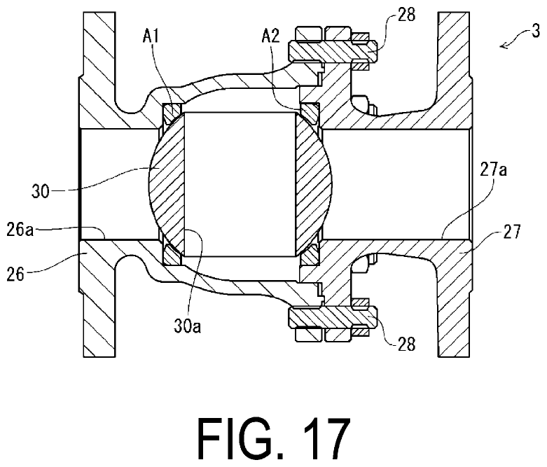

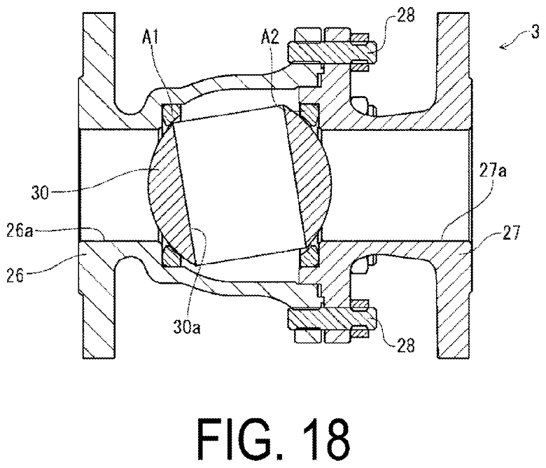

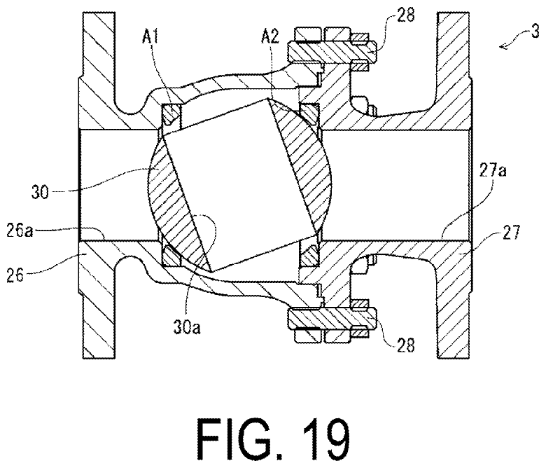

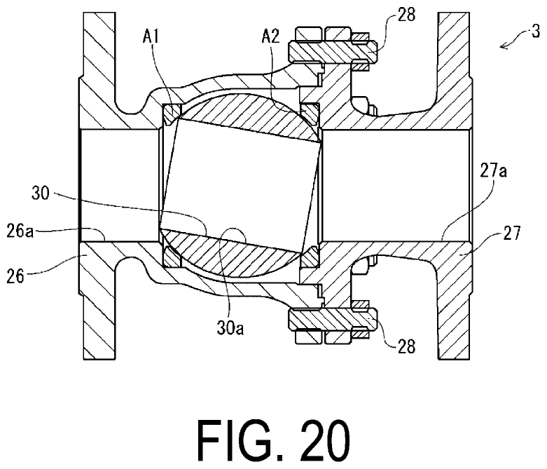

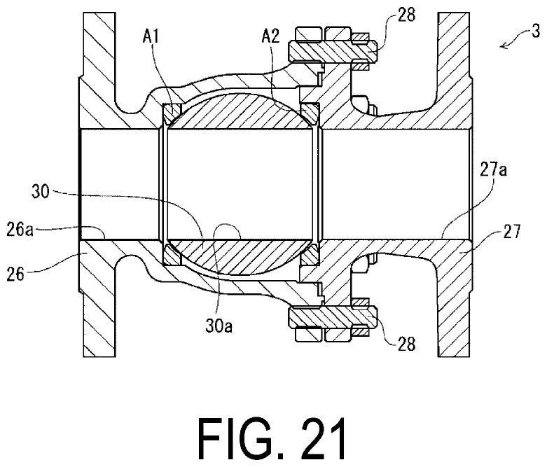

Here, FIG. 17 to FIG. 21 illustrate cross-sectional views taken along line X-X along the axial center of the flow paths 26a, 27a of the ball valve 3 illustrated in FIG. 13, FIG. 14, and FIG. 16. FIG. 17 to FIG. 21 schematically illustrate the valve 3 from fully closed to fully open in the order in which the drawings are numbered, and more specifically are explanatory views of the positional relationship between a through path 30a of the ball 30 and ball seats A1, A2. FIG. 17 illustrates the valve opening degree 0 (fully closed), FIG. 18 illustrates a valve opening degree of approximately 10 degrees, FIG. 19 illustrates a valve opening degree of approximately 20 degrees, FIG. 20 illustrates a valve opening degree of approximately 80 degrees, and FIG. 21 illustrates a valve opening degree of 90 degrees (fully open). A contact ratio between the ball 30 and the ball seat A, given 100% as the state illustrated in FIG. 17, is still 100% in FIG. 18, is decreased to 85% in FIG. 19, is further decreased to 62% in FIG. 20, and is returned to 100% again in FIG. 21.

The ball valve 3 is a floating-type ball valve. A valve box is configured by fixing, by bolts/nuts 28, a body 26 including the flow path 26a on a primary side and a body cap 27 including the flow path 27a on a secondary side. On each of the body 26 and the body cap 27, a flange is formed at a connecting portion of the flow paths 26a, 27a.

The ball 30, which is a valve body, is of a full bore type including a substantially spherical portion and the through path 30a formed to have the same diameter as the those of the flow paths 26a, 27a. The ball 30 is supported from the primary side and the secondary side by the two ball seats A1, A2, which are valve seats having annular shapes. The tightening of the ball 30 by the ball seats A1, A2 is adjusted by the tightening of the bolt/nut 28. At an upper end portion of the ball 30, an engagement portion 29 (for example, a recessed opening engagement portion having a two-surface width) with which the stem 15 (valve stem) can be engaged is formed, and a rotational motion of the ball 30 is transmitted to the stem 15 with high accuracy through this engagement portion 29.

The ball seats A1, A2 are formed of, for example, a resin material such as PTFE or perfluoroalkoxy alkane (PFA). These ball seats A1, A2 are likely to be worn, chipped, displaced, or deformed due to repeated opening and closing operations by the actuators 2 and the like, which may cause valve seat leakage. Such valve seat leakage has an extremely significant influence on the opening and closing of a flow path or flow rate control in a piping system, and thus, to prevent valve seat leakage, it is important to identify a situation such as the wear state of the ball seats A1, A2. In the present embodiment, in addition to the states of the ball seats A1, A2, various diagnostic results such as valve casing leakage, foreign matter intrusion, and actuator failure are acquired as diagnostic information, and an estimation result is output from the estimation unit 120.

The stem 15 is rotatably mounted on a gland portion 31 of the body 26 via a stem bearing B having a cylindrical shape and, between the stem 15 and the gland portion 31, a gland packing C and a packing washer are press-fitted by a packing presser 32. The tightening of the packing presser 32 is adjusted by the tightening of a pressing bolt 33. A bracket 34 that is a coupling member of the main body of the actuator 2 and the ball valve 3 is fixed by bolts 40. At a lower portion of the output shaft 14, a connecting portion (not illustrated) having a rectangular shape is formed, and a fitting portion (not illustrated) formed at an upper portion of the stem 15 is fitted to this connecting portion, coupling the output shaft 14 and the stem 15, whereby a rotational motion of the output shaft 14 is transmitted to the stem 15 with high accuracy.

In FIG. 13, an encoder 37 of a rotary type and indicated by a dashed line is attached to the valve 3 or the actuator 2 in advance before monitoring by the sensor unit 1 according to the present embodiment to acquire necessary data for use in the present invention. In actual use of the present invention, basically, use of the encoder 37 is not assumed. The encoder 37 in the drawing is connected to the upper end portion of control shaft 4 via an attachment plate 36 having a substantially C-shape, and accurately measures at least the angle of rotation of the control shaft 4. The measurement data is then retained as appropriate as unique data.

### Attachment of Sensor Unit 1

The sensor unit 1 can be attached as appropriate to a location where the valve 3 and the actuator 2 can be easily mounted, and is attached to, for example, a location where the unit can be left for a long time without hindering the operation of the valve 3 and the actuator 2. The attachment form of the sensor unit 1 is not limited to the attachment form illustrated in FIG. 13 and FIG. 14 described above. The sensor unit 1 is required to be attached at least in a form of co-rotating accurately with the rotation of the control shaft 4 (rotating shaft).

When the unit is fixed in the form illustrated in FIG. 13 and FIG. 14, a bolt hole of the fitting 5 is aligned with a female screw portion provided at the upper end of the control shaft 4 in the NAMUR standard and, with the fitting 5 oriented in an appropriate fixing direction, the unit can be fixed by simply screwing the bolt 6. Thus, the sensor unit 1 can be easily retrofitted to a predetermined position without removing the existing actuator 2 or the valve 3 from the piping facility, or removing the actuator 2 from the valve 3, or performing any adjustments with the existing instrumentation system, or the like. After such mounting, the rotational motion characteristics of the control shaft 4 can be accurately identified.

The attachment form described above suppresses external protrusion, preventing expansion of the installation space. Thus, the unit can be attached to an automatic valve installed in a narrow space as well. The sensor unit 1 can also be mounted at a position shifted by 180° with respect to the actuator 2 and, even in this case, can be mounted simply by attaching the bolt 6 in a manner similar to that described above. This allows the sensor unit 1 to be provided on any 180° opposing side in accordance with the installation situation of the valve 3 and the actuator 2.

Furthermore, not only in a case in which the valve 3 is in the fully closed state, but also in a case in which the valve 3 is at an intermediate opening degree and the control shaft 4 is in the course of rotation, the sensor unit 1 is attached while positioned as appropriate with respect to this control shaft 4. This allows, even when the automatic valve is in operation, the unit to be accurately attached to allow for initial setting work.

The case of the fitting 5 or the sensor unit 1 can also be changed in accordance with the size of the valve 3 or the actuator 2 while making the outer shape thereof correspond thereto. Furthermore, although the control shaft 4 is provided according to the NAMUR standard in the embodiment described above, the control shaft 4 may be provided according to a standard other than the NAMUR standard. In this case as well, formation is made in accordance with the shape, thereby allowing attachment to the actuator with easy retrofitting, as in the case of the NAMUR standard.

As described above, in the present embodiment, for the degree of abnormality of the valve 3, an aspect illustrating the diagnosis of the ball seat in a 90-degree rotation floating ball valve is described, but the present invention is not limited thereto. For example, detailed diagnosis can be made for a specific portion for a specific symptom by analyzing the shape and pattern of a feature graph (angular velocity graph) generated from data including collected angular velocity data. For example, identification of the wear states of the valve seat, the gland packing, and/or the stem bearing is preferably included.

The degrees of abnormality of the valve and the actuator may be estimated by using not only the analysis of the shape and pattern of the feature graph (angular velocity graph) generated from the data including the collected angular velocity data, but also by using feature amount data acquired from the angular velocity graph.

### Second Embodiment

Another embodiment of the present invention will be described below. For convenience of description, members having the same functions as those described in the embodiment described above are denoted using the same reference signs, and description thereof will not be repeated.

In a valve system 500 according to an embodiment of the present invention, the piping facility PL (FIG. 1), once installed, is used for a long period of time. Accordingly, the sensor unit 1 is left and used for a long period of time, at a level of several years at the longest. On the other hand, in consideration that the gyro sensor 7 consumes a large amount of electric power and the sensor unit 1 is left and used for a long period of time, it is important to select a combination of the gyro sensor 7 and the power supply 11 of the sensor unit 1 from the viewpoint of power saving. In addition, the power saving function is also important for the sensor unit 1 and the valve system 500 (FIG. 1) as a whole.

In consideration of the power saving function of the gyro sensor 7 itself, for example, a gyro sensor of a self-generation type (such as vibration power generation or photovoltaic power generation) can be used.

Furthermore, as an example, the CPU 8 may be normally set to a power saving state and receive data from the gyro sensor 7 but not accumulate the data in the memory 9. Then, when operation of the actuator 2 is detected, the power saving state may be released and at least the angular velocity data detected by the gyro sensor 7 may be accumulated in the memory 9. The state may be returned to the power saving state after the state in which operation of the actuator 2 is not detected continues for a predetermined time.

Modes provided with such a power saving function include other aspects such as described below.

### Configuration of Information Processing System

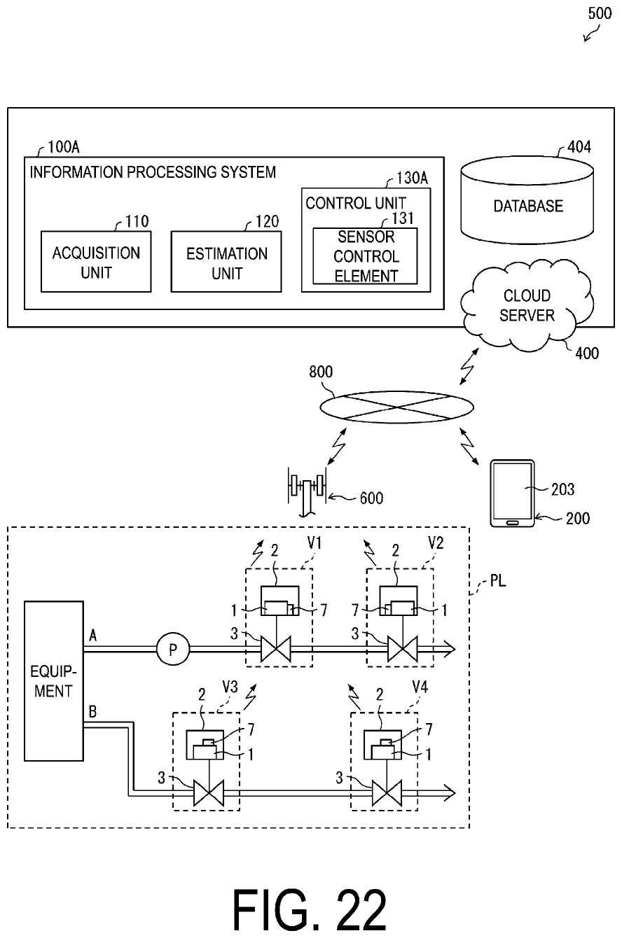

An information processing system 100A according to the present embodiment illustrated in FIG. 22 includes the acquisition unit 110, the estimation unit 120, and a control unit 130A that controls these.

The information processing system 100A according to the present embodiment differs from the information processing system 100 according to the first embodiment described above in including the control unit 130A obtained by adding another function added to the functions of the control unit 130 of the information processing system 100 according to the first embodiment. More specifically, in the information processing system 100A, the control unit 130A includes a sensor control element 131 (sensor control unit) having a gyro-sensor control function for controlling the gyro sensor 7, and activates the gyro sensor 7 in a specific time period.

### Control Unit 130A

The sensor control element 131 included in the control unit 130A activates the gyro sensor 7 in a specific time period. The specific time period is one hour every 12 hours, one hour from 9:00 am to 10:00 am every day, or a day of the week other than days on which the valve system or the piping facility PL is known not to operate in advance. The control unit 130A has a timer function.

The interval between the specific time period and the next specific time period does not need to be constant. Taking into consideration the aging of the valve system and piping facility PL, the interval may gradually shorten over time or may shorten from a certain point in time.

The sensor control element 131 of the control unit 130A, in other words, suspends the operation of the gyro sensor 7 during time periods other than the specific time period. As a result, the gyro sensor 7 enters a sleep state, making it possible to suppress the power consumption by the gyro sensor 7. The gyro sensor 7 can be controlled from the control unit 130A via the CPU 8 of the sensor unit 1.

### First Modified Example

Abnormalities of the valve 3 and the actuator 2 are not expected to occur when first installed, but are expected to occur more frequently as the usage count thereof increases. Therefore, in another modified example of the present embodiment, the sensor control element 131 of the control unit 130A activates the gyro sensor in response to an increase in the usage count of the valve 3 and the actuator 2 or the usage count reaching a certain count.

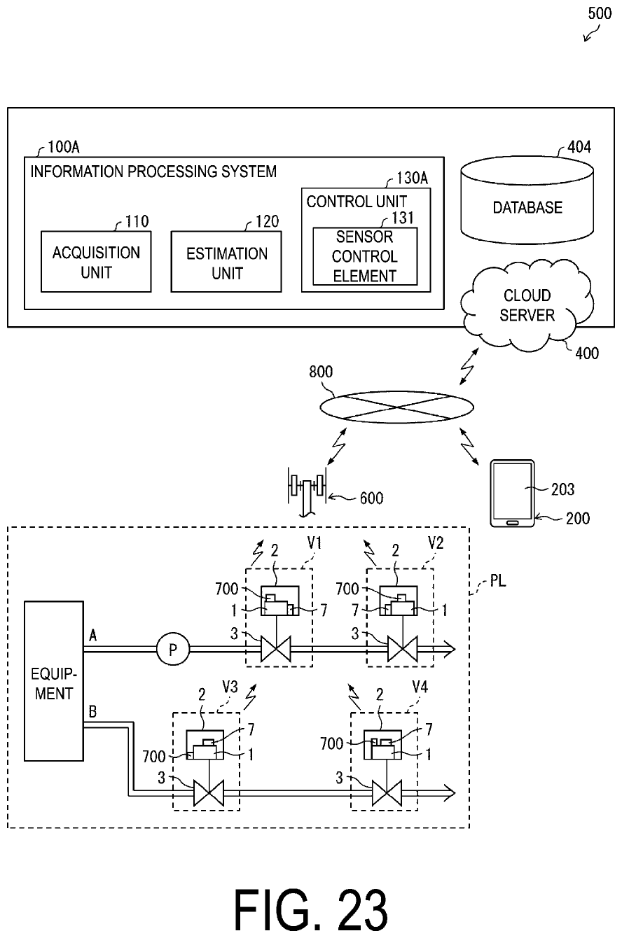

Specifically, in the information processing system 100A according to the present embodiment illustrated in FIG. 23, the acquisition unit 110, in addition to acquiring the angular velocity data, further acquires a detection signal indicating the start of rotation of the rotating shaft based on the second sensor 700 for detecting the rotation of the rotating shaft. Then, the sensor control element 131 of the control unit 130A activates the gyro sensor 7 in response to the number of times the acquisition unit 110 acquires the detection signal reaching a specific count.

Here, the second sensor 700 that transmits the detection signal of the start of rotation of the rotating shaft is preferably a sensor having a driving power lower than that of the gyro sensor 7, and is preferably a sensor that detects the rotation of the output shaft 14 of the rotating shaft. Examples of the second sensor 700 include an acceleration sensor and a geomagnetic sensor.

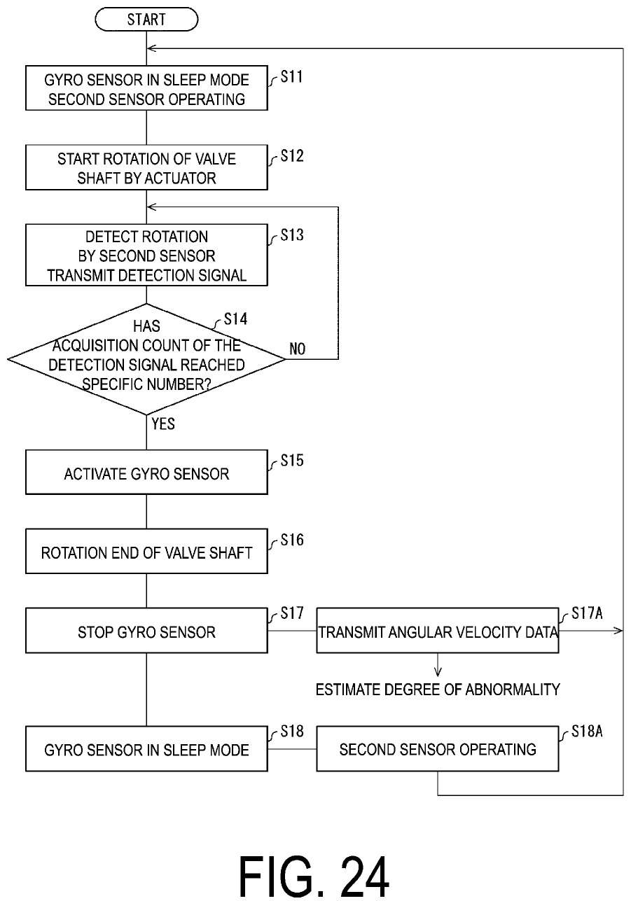

Hereinafter, an operation flow of the information processing system 100A according to this modified example will be described with reference to FIG. 24.

In the information processing system 100A, the gyro sensor 7 is in a dormant state until the second sensor 700 detects the start of rotation of the rotating shaft (step S10).

Then, when the actuator 2 starts the rotation of the rotating shaft (step S12), the second sensor 700 detects the start of the rotation of the rotating shaft and transmits the detection signal (step S13). The detection signal transmitted by the second sensor 700 is acquired by the acquisition unit 110, and the sensor control element 131 of the control unit 130A determines whether the number of times the acquisition unit 110 acquires the detection signal has reached a specific count (step S14).

Then, when it is determined that the number of times the acquisition unit 110 acquires the detection signal has reached the specific count, the sensor control element 131 activates the gyro sensor 7 via the CPU 8 (step S15). This allows the gyro sensor 7 to detect the angular velocity data. On the other hand, when the sensor control element 131 determines in step S14 that the number of times the acquisition unit 110 acquires the detection signal has not reached the specific count, the processing returns to step S13.

Subsequently, when the actuator 2 stops the rotation of the rotating shaft (step S16), the gyro sensor 7 stops the detection of the angular velocity data (step S17). At the same time, the angular velocity data is transmitted from the gyro sensor to the acquisition unit 110 via the memory 9 (step S17A), and the degrees of abnormality are estimated as described above. During the period from step S15 to step S17, the second sensor 700 may operate or may stop operating.

The gyro sensor 7, once stopped, enters a sleep mode when a predetermined time has elapsed (step S18). At this time, the second sensor is operating (step S18A).

The acquisition unit 110 may determine whether the number of times the acquisition unit 110 acquires the detection signal has reached the specific count. The specific count can be set as appropriate. The sensor unit 1 may detect the number of times the detection signal is transmitted from the second sensor 700 instead of the number of times the acquisition unit 110 acquires, and the angular velocity data may be acquired by the acquisition unit 110 from the sensor unit 1 when the number of times reaches a predetermined number of times. For example, the CPU 8 may count the number of times.

As described above, according to the present embodiment and the modified example, the gyro sensor 7 is not continuously driven, but rather driven for a specific period, making it possible to contribute to power saving.

In the modified example, the gyro sensor 7 is driven on the basis of the detection signal indicating detection of the start of rotation of the rotating shaft by the second sensor 700. However, the present invention is not limited thereto. For example, in a case in which the sensor unit 1 has a power generation function, such as a photovoltaic power generation function, an aspect may be adopted in which the gyro sensor 7 is driven in accordance with an amount of charge. For this, for example, an aspect may be adopted in which, on the basis of a configuration in which the amount of charge is detected, operation of the gyro sensor 7 is suspended when the amount of charge is less than a predetermined threshold, and the gyro sensor 7 is activated again when the amount of charge is equal to or greater than the predetermined threshold through power generation.

### Third Embodiment

Another embodiment of the present invention will be described below. For convenience of description, members having the same functions as those described in the embodiment described above are denoted using the same reference signs, and description thereof will not be repeated.

As another form of the aspect for achieving power saving as in the second embodiment described above, the present embodiment suppresses the power related to the transmission of the angular velocity data of the gyro sensor 7 until the angular velocity data is acquired by the acquisition unit 110 of the information processing system 100.

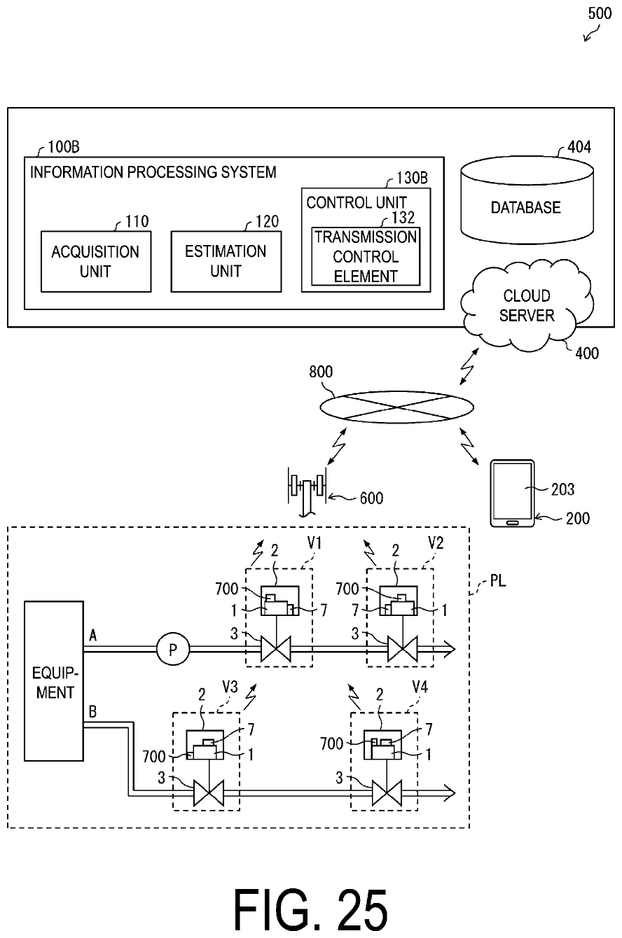

More specifically, an information processing system 100B according to the present embodiment illustrated in FIG. 25 includes the acquisition unit 110, the estimation unit 120, a control unit 130B that controls these, and the database 404.

The information processing system 100B according to the present embodiment differs from the information processing system 100 according to the first embodiment described above in including the control unit 130B obtained by adding another function to the functions of the control unit 130 of the information processing system 100 according to the first embodiment. More specifically, in the information processing system 100B, the control unit 130B includes a transmission control element 132 (transmission control unit) that controls transmission from the gyro sensor 7 to the acquisition unit 110. This transmission control element 132 transmits angular velocity data to the acquisition unit in response to one or both of a specific time period and the number of times the gyro sensor detects the angular velocity data of the rotating shaft reaching a specific count.

### Control Unit 130B

The transmission control element 132 included in the control unit 130B can execute control so that the acquisition unit 110 acquires the angular velocity data from the sensor unit 1 in a specific time period. The specific time period is one hour every 12 hours, one hour from 9:00 am to 10:00 am every day, or a day of the week other than days on which the valve system or the piping facility PL is known not to operate in advance. The control unit 130B has a timer function.

The interval between the specific time period and the next specific time period does not need to be constant. Taking into consideration the aging of the valve system and piping facility PL, the interval may gradually shorten over time or may shorten from a certain point in time.

The transmission control element 132 may control the sensor unit 1, may control the acquisition unit 110, or may control both so that the acquisition unit 110 can acquire the angular velocity data from the sensor unit 1 in the specific time period. In an aspect in which the sensor unit 1 is controlled, the CPU 8 is controlled as an example.

When the angular velocity data is transmitted from the sensor unit 1 to the acquisition unit 110, electricity is consumed. Therefore, by limiting the transmission period to a specific time period, it is possible to suppress the power consumption related to transmission.

That is, as an example, the timing at which the gyro sensor detects the angular velocity data may differ from the timing at which the angular velocity data is transmitted from the sensor unit 1 to the acquisition unit 110. As a specific example, there may be an aspect in which the gyro sensor 7 continues to detect the angular velocity data while the rotating shaft is rotating, but the angular velocity data is transmitted to the acquisition unit 110 only once per hour. Alternatively, as a specific example, there may be an aspect in which the gyro sensor 7 continues to detect the angular velocity data while the rotating shaft is rotating, but the angular velocity data is transmitted to the acquisition unit 110 only during the period from 9 am to 10 am every day.

The transmission control element 132 can transmit the angular velocity data to the acquisition unit 110 in response to the number of times the gyro sensor 7 detects the angular velocity data of the rotating shaft reaching a specific count instead of or in addition to the aspect of transmission in the specific time period. As an example, a configuration is adopted in which, once the gyro sensor 7 detects angular velocity data ten times, the detected angular velocity data is transmitted to the acquisition unit 110. The angular velocity data transmitted at this time may be a portion of the data detected across the ten times, and that portion may be data in which a specific feature appears. The determination as to whether the number of times the gyro sensor 7 detects the angular velocity data of the rotating shaft has reached the specific count is made in the CPU 8 of the sensor unit 1, for example.

The aspect described above can implement power saving related to transmission.

In this form, description is made of a transmission mode in which the angular velocity data transmitted from the sensor unit 1 is transmitted from the sensor unit 1 to the gateway 600 while being acquired by the acquisition unit 110 via the gateway 600. However, without limitation to the gateway 600, power saving related to transmission can be achieved by realizing the contents described above in a transmission path somewhere between the sensor unit 1 and acquisition by the acquisition unit 110.

### First Modified Example

As an aspect that takes into consideration power consumption related to transmission as in the present embodiment, there may be an aspect in which the acquisition unit 110 does not acquire the angular velocity data detected by the gyro sensor as is, but rather is caused to acquire processed data obtained by processing the angular velocity data as is into data smaller than the data volume of the angular velocity data.

As an example, the transmission control element 132 of the control unit 130B transmits, to the acquisition unit 110, compressed data obtained by combining a plurality of angular velocity data detected by the gyro sensor 7 and compressing the data volume. This can reduce power consumption related to transmission than a case of transmission of the angular velocity data having the data volume as detected from the gyro sensor 7.

### Second Modified Example

As in the embodiment described above, as a form of the present invention, the estimation unit 120 may be configured so that, without restriction to a graph comparison, the acquisition unit 110 acquires a numerical value of the angular velocity data detected at a specific valve opening degree (for example, a valve intermediate opening degree) from the angular velocity data detected by the gyro sensor 7, for example. Then, the estimation unit 120 may estimate the degree of abnormality by comparing the numerical value with that of the comparative angular velocity data. In this case, the numerical value of angular velocity data acquired by the acquisition unit 110 may include data of a representative value representing a behavior of a certain rotating shaft based on a plurality of angular velocity data detected by the gyro sensor 7 that detects the angular velocity data of the certain rotating shaft. As an example, the representative value representing the behavior of the rotating shaft includes an integrated value, an average value, or a standard deviation value of the angular velocity data with a certain valve opening degree range (for example, a valve opening degree range from 0° to 20°). In this case, the representative value based on the comparative angular velocity data is also stored in the database 404, similarly to the comparative angular velocity data.

In short, in the present modified example, the transmission control element 132 of the control unit 130B transmits, to the acquisition unit 110, data of a representative value representing a behavior of a certain rotating shaft based on a plurality of angular velocity data detected by the gyro sensor 7 that detects the angular velocity data of the certain rotating shaft. The representative value is, for example, calculated by the sensor unit 1.

In this way, not all but only a portion of the data of the angular velocity detected by the gyro sensor 7 is transmitted to the acquisition unit 110 via the gateway 600. This can achieve power saving related to transmission.

### Third Modified Example

As another modified example, the transmission control element 132 of the control unit 130B may control the transmission of the angular velocity data to the acquisition unit 110 on the basis of the rotation angle of the valve body (ball 30 in FIG. 16), that is, the rotation angle of the stem 15 (FIG. 16), instead of transmitting the data on the basis of a specific time or a specific number of times of detection as described above. Specifically, a configuration may be adopted in which the angular velocity data corresponding to only when the rotation angle of the valve body, that is, the rotation angle of the stem 15, is within a specific angle range is transmitted to the acquisition unit 110.

Specifically, for example, a configuration is adopted in which only the portion corresponding to when the rotation angle of the stem 15 is from 10 degrees to 20 degrees is transmitted. This can achieve power saving related to transmission.

In the case of an aspect in which the gyro sensor 7 detects ten points of angular velocity data per second in one valve operation of the valve 3 (operation of the valve 3 rotating from 0 degrees to 90 degrees or rotating from 90 degrees to 0 degrees), the data volume increases in proportion to the time required to open and close the valve 3. Therefore, in the present modified example, an average angular velocity for every 10 degrees is transmitted as the angular velocity data. Accordingly, the data of 9 points (90 degrees) is acquired per open/close operation of the valve 3 regardless of the open/close time of the valve 3. Thus, power saving related to transmission can be implemented. In the case of the present modified example, on the sensor unit 1 side, the average angular velocity is calculated and transmitted to the acquisition unit 110.

### Fourth Modified Example

The function of the transmission control element 132 described in the present embodiment and the modified examples described above may be implemented by another constituent element of the information processing system 100 or may be implemented by a constituent element of the sensor unit 1. Examples of an aspect of realization by a constituent element of the sensor unit 1 include realization by the CPU 8.

In this case, the sensor unit 1 can be regarded as a transmission system that transmits angular velocity data to an external device in order to estimate the degree of abnormality of each of the actuator 2 and the valve 3 by referring to the angular velocity data of the rotation of the rotating shaft. Then, the sensor unit 1 as the transmission system includes the CPU 8 as a transmission control unit that controls the transmission of the angular velocity data. The CPU 8 transmits only some of the plurality of angular velocity data detected by the gyro sensor 7 to the external device (external server or the acquisition unit 110 of the information processing system 100B) in response to one or both of a specific time period and the number of times the gyro sensor 7 detects the angular velocity data of the rotating shaft reaching a specific count.

As a specific example of the CPU 8 of the sensor unit 1 as this transmission system, the CPU 8 may be configured to externally transmit data of a representative value representing a behavior of a certain rotating shaft on the basis of the plurality of angular velocity data detected by the gyro sensor that detects the angular velocity data of the certain rotating shaft. The representative value is the same as that described above, and thus description thereof will be omitted.

Furthermore, as another specific example of the CPU 8 of the sensor unit 1 as the transmission system, the CPU 8 may be configured to transmit, to an external device (external server or the acquisition unit 110 of the information processing system 100B), data obtained by combining a plurality of angular velocity data detected by the gyro sensor and compressing the data volume, thereby processing the data into a data volume less than the total data volume of the plurality of angular velocity data.

### Fourth Embodiment

Another embodiment of the present invention will be described below. For convenience of description, members having the same functions as those described in the embodiment described above are denoted using the same reference signs, and description thereof will not be repeated.

Individual valve units provided in a specific piping system are each in a specific usage state, including a pipeline position. Therefore, when monitoring arranged valve units and the like, by also incorporating such individual specific usage states as information, it is possible to increase the range and accuracy of use of the output information for abnormality detection, state prediction, even machine learning applications for each valve and actuator or piping system, and the like. For example, even in valve units in which the valves are the exact same model, size, material or the like, the load varies in accordance with the specific state in which the valve is arranged, such as the pipeline position. As a result, the lifetime, required maintenance, or management cost of the valve unit varies in accordance with the state of the load.

Therefore, in the present embodiment, an aspect that takes into consideration information acquired from the piping system will be described.

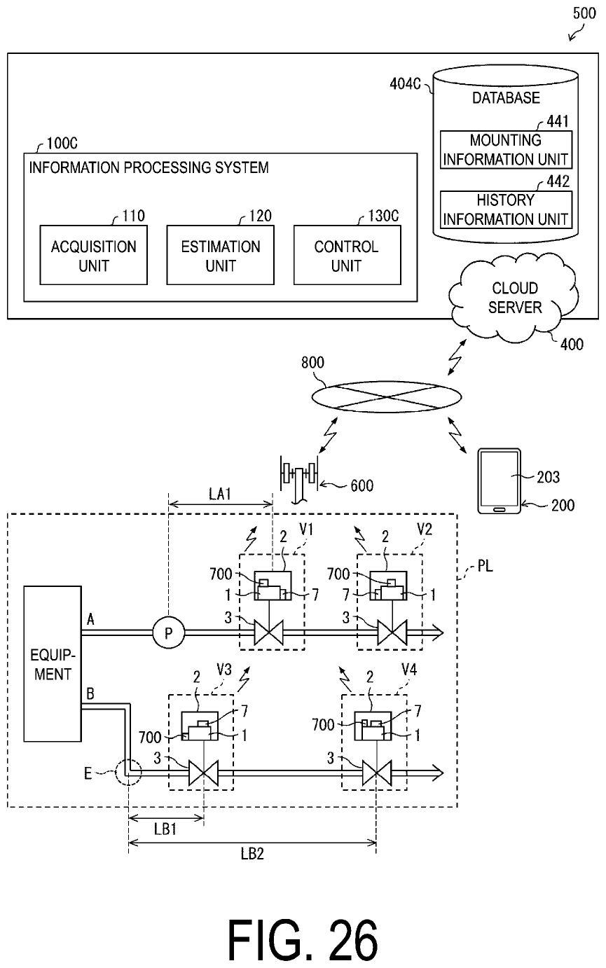

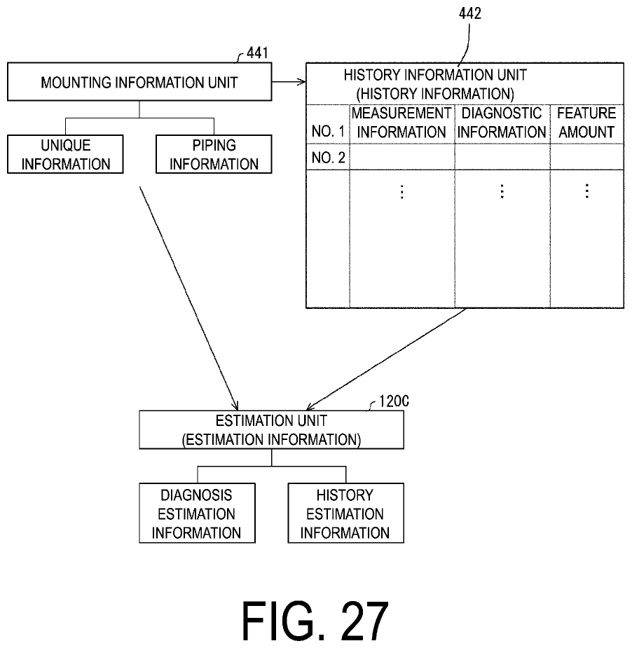

FIG. 26 illustrates a configuration of the valve system 500 of the present embodiment. FIG. 27 illustrates a configuration of a database 404C in the server 400.

In the present embodiment, the database 404C illustrated in FIG. 26 includes a mounting information unit 441, which is mounting information of the valve unit, and a history information unit 442, which is updated when valve or actuator required work occurs, the update being made using information corresponding to the work. Then, on the basis of the information of the mounting information unit 441 and the history information unit 442, an estimation unit 120C outputs predetermined estimation information.

### Mounting Information of Mounting Information Unit 441

The mounting information unit 441 in the database 404C illustrated in FIG. 27 is provided with mounting information, which includes at least the unique information of the valve 3 and the actuator 2 and piping information.

The unique information is provided to individually identify the valve and the actuator. Although not illustrated, the unique information of the valve includes various information such as, for example, the valve order number or user management number, the valve type classified by the form or function of the valve, (main) material or nominal diameter of the valve, fluid handled by the valve, features such as the pressure of this fluid, flow rate or open/close frequency of the valve, type or performance of the actuator, or, in a case in which the valve is a ball valve, the material or wear coefficient of the ball seat or packing, and the size of the ball or the flow path, for example. Basically, the information of the valve indicated in a valve specification or the like is converted into predetermined numerical values or symbols and retained. The unique information of the actuator includes information such as model, order number, product number, user management number, high-pressure gas approval number, or accessory information.

The piping information includes information related to the load applied to the valve. The information related to the load applied to the valve (load information) is information that affects the failure period or the lifetime. The information related to the load applied to the valve may include information related to the valve itself (the pump P, the valve 3 of the valve unit V2, the open/close frequency of the valve 3 of this valve unit 2, and the like in the case of the valve unit V1; and an elbow E, the valve 3 of valve unit V3, the open/close frequency of the valve 3 of valve unit V4 in the case of the valve 3 of valve unit V4; and the like), information related to temperature, moisture, and changes thereto in the operating environment where the valve is arranged, differentiation of the type of pipe to which the valve is connected (main or branch), information related to the vibration or corrosive atmosphere of the operating environment and the stresses to which the valve is subjected by the piping, information related to the bore diameter of the piping or the actual fluid used (temperature, pressure, flow rate, and the like), information related to the type of fluid, particle size in the fluid, viscosity, as well as whether the usage conditions of the valve meet the manufacturer warranty conditions, and the like. Such piping information is converted into predetermined numerical values or symbols and retained as with the unique information.

The piping information may include, as information related to the load applied to the valve (load information), valve attachment posture information indicating whether the valve is installed using a horizontal piping type or a vertical piping type. In a case in which the valve is installed using a vertical piping type, when the valve is fully closed, even if the fluid is normal water, hydraulic head pressure is always applied to the valve as a load, and thus the lifetime is short compared with that of a horizontal piping. If slurry inside the fluid or a component contained in the fluid sticks or crystallizes and accumulates, a greater load may be imposed on the valve than the magnitude of the load on the valve when installed using a horizontal piping type, such as at the sealing portion. As described above, because the load applied to the valve varies depending on whether the piping type is vertical or horizontal, the type is included in the piping information as the valve attachment posture information. The load applied to the valve differs depending on the presence or absence of a reducer in the piping and by the elbow. Accordingly, preferably such information representing the load applied to the valve is also included in the piping information together with the valve attachment posture information.

For example, the present inventors have found through intensive studies that the presence of a reducer affects the lifetime of the valve to a certain extent (for example, as much as 20%) as compared with a case in which a reducer is not present. Therefore, the presence or absence of a reducer is included in the piping information as information indicating the load applied to the valve, and the lifetime is predicted assuming that, for example, 20% of the time (the number of openings and closings) has elapsed when a reducer is present compared with when a reducer is not present. As an example, in a case in which an expected lifetime of the valve is an open/close count of 50000, the lifetime is determined to be an open/close count of 40000 for a valve with a reducer and 50000 times for a valve without a reducer. This applies not only to the presence or absence of a reducer but also to the whether the piping is a vertical piping type and to the presence or absence of pump installation.

As described above, it is possible to predict the failure period or the lifetime with high accuracy by identifying the load information. Accordingly, in a large-scale valve system such as illustrated in FIG. 26, even if only a very small number of valves are abnormal at the time of maintenance, the seat components of all valves of the same type are fully replaced. As a result, problems have occurred such as an increase in maintenance cost, an increase in the number of times of replacement when only failed valves are maintained, and a decrease in the overall operating rate because the valve system is stopped during that time. With the highly accurate prediction according to the present embodiment, a remarkable effect of reducing the maintenance cost of the entire valve system and increasing the operating rate is achieved.

The load information may include, in addition to the content described above, information related to the position of the valve provided to the piping. In a case in which a valve or the like, which is a specific element in the piping systems A, B of FIG. 26, is arranged, the piping is specified as information specific to the element. The piping systems A, B may flow into or out from a device, and one piping system may be defined as appropriate in accordance with the implementation, for example, a system that handles the same fluid. In this case, this means a pipe structure with continuous internal connections necessary for the same fluid to flow from upstream to downstream in a predetermined section. Although not illustrated, the piping information of the position where a certain valve is arranged includes at least a distance to each element (including a case of three or more elements) closest to the primary side and the secondary side of the valve. In the case of FIG. 26, the piping information of the valve 3 of the valve unit V1 includes a distance LA1 to the pump P adjacent thereto on the left side of the drawing and a distance (LA2−LA1) to the valve 3 of the valve unit V2 adjacent thereto on the right side of the drawing. Similarly, the piping information of the valve 3 of the valve unit V3 includes a distance LB1 to the elbow E adjacent thereto on the left side of the drawing and a distance (LB2−LB1) to the valve 3 of the valve unit V4 adjacent thereto on the right side of the drawing. In the present embodiment, the pump P or the elbow E is illustrated as an example of an element by which the flow rate changes for the fluid in the piping.

The piping information is information for appropriately extracting and converting into data factors affecting the flow of the fluid handled by the valve. The piping information can be selected as appropriate in accordance with the implementation. However, when the information increases excessively, difficulties arise in utilizing the mounting information described below for new valves. For this reason, the piping information should consist of only the minimum amount of effective information possible.

Examples of elements of the piping system in the piping information described above include various piping devices provided in the piping system, such as a valve, a pump, and a tank. In addition, the elements may include a branch (T-tube), a vent (elbow), a contraction, or the like that is a piping section having a form other than a straight pipe where the flow of fluid is affected, or a joint (flange), a support section, or the like.

### History Information of History Information Unit 442

The history information of the history information unit 442 of FIG. 27 includes at least predetermined measurement information obtained by measuring the open/close operation of the valve 3 by the sensor unit 1, and diagnostic information obtained by diagnosing the valve 3 and the actuator 2 in accordance with this measurement information. The history information unit 442 may include, in addition to the measurement information or the diagnostic information, a feature amount described below, may further include information other than this, and may accumulate various information in accordance with the implementation.

The measurement information can be acquired in accordance with the open/close driving of the valve 3. In the present embodiment, as described below, predetermined measurement information (angular velocity information or the like) can be acquired by the sensor unit 1 that includes the gyro sensor 7, and an information processing system 100C can acquire a predetermined feature amount (a feature necessary for machine learning expressed as a variable by a quantitative numerical value) from the measurement information. As described below, as a feature amount, in addition to the data itself of the two dimensional angular velocity graph image based on the angular velocity graph information, a set of predetermined feature amounts extracted from the angular velocity graph information can be used.

The diagnostic information is information obtained by converting into data all information (symptoms) that can be regarded as a diagnostic result of the valve on the basis of the measurement information. The diagnostic information can be set in advance as appropriate in accordance with the implementation and includes, for example, information from general symptoms common to all valve types, such as valve seat leakage, valve box leakage, foreign matter intrusion, and actuator failure to, depending on the valve type, ball seat misalignment, deformation, wear, or loss in the case of a ball valve, for example, or entry of fluid into a cavity, stem deformation, and corrosion or damage of specific components in accordance with a special operating environment. These diagnostic results are converted as appropriate into numerical values or symbols that can be uniquely identified to constitute diagnostic information.

The history information including the measurement information and the diagnostic information described above is used to record predetermined information corresponding to the work content and accumulate the information in the database 404C when at least some work such as maintenance is performed at the time of an abnormality on the valve 3 to which the sensor unit 1 is attached. For example, as described below, when a notification is issued for an abnormality of the valve 3 from the sensor unit 1 or the like, necessary work is performed on the valve. The diagnostic information related to the symptom of the valve 3 acquired at that time is recorded as history information, and the feature amount corresponding to the operation at the time of the abnormality is also recorded in correspondence with the diagnostic information.

Therefore, the history information unit 442 includes at least the feature amount acquired on the basis of measurement information described above and the diagnostic information related to the symptom of the valve open/close operation when the sensor unit 1 recorded the feature amount, but may additionally include predetermined content in accordance with the work. For example, when work is performed on the valve 3 for which a notification of an abnormality was issued as described above, this work is typically recorded as information required in a predetermined format, such as a work report, but such content may be (converted into data and) included in the history information. For example, although not illustrated, in the case of work for replacing a ball seat of a ball valve, damage such as the amount of wear or the amount of swelling of this ball seat, or in a case in which scales are attached, the type and weight of the scales, the attachment location, the film thickness, and the like may be converted into data in a predetermined format and included in the history information.

In this way, basically, when abnormalities of the valve 3 and the actuator 2 are recognized as described above, various information related to the valve 3 is recorded in the database 404C as history information. The history information unit 442 may include information related to not only such times of an abnormality, but also related to normal times (when no work is performed). In this case, the history information can be treated as periodic information of the valve 3 of a predetermined time interval. As illustrated in the drawing, a number may be assigned to each set of history information (record). However, as described below, it is not assumed that each record is handled as time-series data. For this reason, the history information composed of these records does not need to be in the order of time, and can be utilized by being appropriately combined or divided as in the case of data transferring described below.

The correspondence between the mounting information of the mounting information unit 441 and the history information of the history information unit 442 may be either one-to-one or one-to-many. In the present embodiment, the fact that a plurality of valves can be replaced and used at specific pipeline positions is taken into consideration and thus, for example, the piping information and the unique information have a one-to-many correspondence. When the history information is associated with each valve unit (valve), the mounting information of the mounting information unit 441 and the history information of the history information unit 442 have a one-to-one correspondence, and when the history information is associated with a certain pipeline position, the mounting information and the history information unit have a one-to-many correspondence.

Here, an example of the correspondence relationship between the “Mounting information” of the mounting information unit 441 and the “History information” of the history information unit 442 will be described. First, as the “Unique information” of the “Mounting information,” a nominal pressure or a nominal diameter, a material, and a valve type of the valve, for example, a floating type ball valve made of SUS304 of class 150 having a nominal diameter 100 A (as data actually input, “150UTB100,” which is a model number of a valve manufactured by the applicant) is first used.

Second, for example, “P01AV1-01” (meaning: plant number P01, piping system A, valve unit number V1, version number 01) is used as the user management number, and third, for example, “Powder” or “Temperature of fluid” is used as the fluid information. These are merely examples, and information such as a the open/close frequency may be added. Further, as the “Piping information” of the “Mounting information,” the load information “Vertical piping type” is used as described above.

Next, as “History information,” for the data of No. 1, “Use start date” is input as the “Measurement information,” and “None” is input as “Diagnostic information” or “Feature amount.”

Next, for the data of No. 2, “The number of openings and closings of 1000” is input as the “Measurement information,” “1 mm wear of ball seat” is input as “Diagnostic information,” and “Approximately 30% rise in peak value T2 of angular velocity at intermediate opening degree” is input as “Feature amount.”

Further, for the data of No. 3, “The number of openings and closings of 10000” is input as the “Measurement information,” “Operation stopped due to sticking” is input as “Diagnostic information,” and “Angular velocity zero at intermediate opening degree” is input as “Feature amount.”

Then, in a case in which the valve unit was replaced, the “Unique information” of the mounting information unit 441 is changed. For example, “P01AV1-02” (meaning: plant number P01, piping system A, valve unit number V1, version number 02) is used. The “Piping information” is not changed. In this way, the “Piping information” and the “Unique information” in the mounting information unit 441 have a one-to-many relationship.

As described above, information obtained by adding “Measurement information” to “Unique information” and “Piping information” under “Mounting information” of the mounting information unit 441 and to “Diagnostic information” and “Feature amount” under “History information” of the history information unit 442 is used as information.

Although the term “input” is used in the above description, the term includes not only manual input but also automatic input from a sensor or the like. The input content is also input using explanatory text such as “30% rise in angular velocity,” but is not limited thereto, and may be input using a parameter and a numerical value.

The configuration in the database 404C described above may be included in the information processing system 100C.

In the present embodiment, the information processing system 100C illustrated in FIG. 26 outputs estimation information in the estimation unit 120C on the basis of the information of the history information unit 442 and the mounting information unit 441 described above.

The estimation unit 120C estimates the degrees of abnormality of the valve 3 and the actuator 2 using the feature amount acquired from the angular velocity graph.

Here, the feature amount data may be a time from fully open to a predetermined opening degree of the valve V appearing in the angular velocity graph (for example, a time from 0 degrees to 10 degrees or a time from 0 degrees to 30 degrees), a fully closed time from fully open to fully closed, or a time from a predetermined opening degree to fully closed (for example, a time from 80 degrees to 90 degrees). The feature amount data may be a number of steep gradients, and a position, magnitude, and/or width of each steep gradient of angular velocity included in a predetermined time region. The feature amount data may be a time until the angular velocity reaches a maximum value or a local maximum value, or a magnitude or width of the maximum value or the local maximum value. Alternatively, all or a portion of these may be included. Furthermore, the feature amount may be a start/end time of a predetermined time and, as for a leakage amount, the presence or absence of leakage (binary value). In accordance with these types of the feature amounts, feature amount data as numerical data (scalars, vectors) is generated. Data acquired by processing (so-called preprocessing) the acquired measurement data, for example, an average angular velocity or a maximum angular velocity in a predetermined opening degree range, may be used as a feature amount.

Here, a steep gradient indicates, for example, a portion of the angular velocity graph where the valve opening degree changes abruptly, appearing in one or more uneven positions biased with respect to the time axis between fully open and fully closed, as shown in FIG. 5. A gradient for being read as a steep gradient (rate of change) can be set as appropriate in accordance with the implementation.

The number of steep gradients is, for example, the number of steep gradients appearing on a graph and their readable times. The position of a steep gradient may be, for example, a time when the steep gradient starts or ends or a time in the middle of these times, or may be a time of the maximum value in the case of a unimodal locus. A displacement of a steep gradient is, for example, a difference between values (opening degrees or angular velocities) corresponding to the start and end times of the steep gradient, and may be set to peak height of an appropriate maximum value in the case of a unimodal locus. Similarly, the width of the steep gradient is, for example, a difference between the start and end times of the steep gradient, and may be set to a width corresponding to the peak height of an appropriate maximum value in the case of a unimodal locus.

In this manner, when a feature easily identifiable appears in the pattern of data that can be acquired in accordance with one cycle of the opening and closing of a valve, the magnitude of the amount of information required for processing can be reduced or optimized in the data statistical operation described below.

In particular, the angular velocity graph by the gyro sensor can be easily characterized, facilitating the generation of teaching data (test data) as described below. For sensors other than gyro sensors, a feature does not readily appear in the pattern of data that can be acquired in accordance with valve opening and closing. Accordingly, in a case in which information with less features is used for machine learning, it is necessary to separately perform statistical processing to extract features and use most or all of the acquired data. On the other hand, in the angular velocity graph data used in the present embodiment, a characteristic steep gradient readily appears. Thus, with only a small amount of information (a set of several numerical values, such as position, quantity, displacement, and/or width) related to the steep gradient, the statistical operation can be performed with high accuracy, thereby saving computation resources.

Such feature amount data acquired from the angular velocity graph information is used as a portion of the measurement information of the history information unit 442 through the control unit 130C of the information processing system 100C. Then, the history information including this measurement information and the mounting information of the mounting information unit 441 are associated with each other and accumulated in the database 404C (first step). Subsequently, on the basis of the mounting information or the history information, predetermined estimation information is output by the estimation unit 120C (second step).

In the present embodiment, the estimation information in the estimation unit 120C includes at least diagnostic estimation information and history estimation information as illustrated in FIG. 27, and such estimation information is output through the control unit 130. Hereinafter, the operation at the time of execution of each function will be described, but the present invention is not limited thereto, and appropriate processing may be performed in accordance with the implementation.

For example, as the feature amount data of the history information, the two-dimensional angular velocity graph image data itself acquired from the angular velocity information (or image data subjected to predetermined data processing so as to be suitable as input data of machine learning) can be used as a portion of the measurement data. In particular, as described below, application to methods of machine learning (deep learning) related to image recognition, which has been remarkably developed in recent years, is effective. In particular, in this case, it is physically preferable to use a graphics processing unit (GPU).

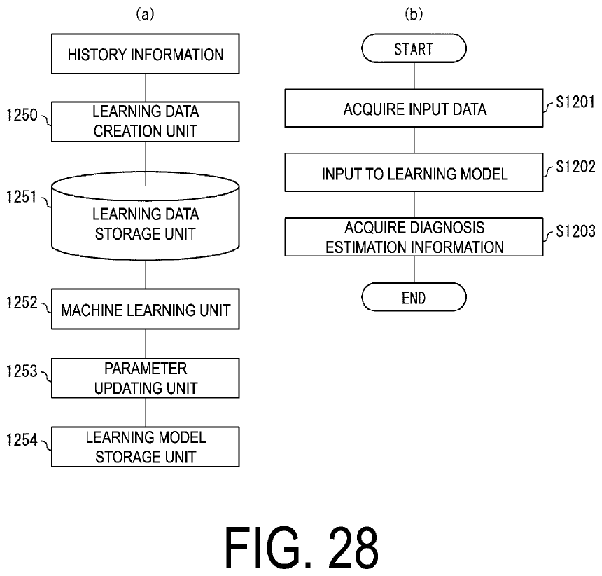

During the operation of the estimation processing of FIG. 28, the information processing system 100C has a function of generating, in the same mounting information, a predetermined feature amount from predetermined measurement information measured from the valve to which the sensor unit 1 is attached, by the history information unit 442. Furthermore, the information processing system 100C is equipped with a function of assigning the diagnostic information of the valve corresponding to when this measurement information was acquired to this feature amount as a learning label, thereby generating learning data. The information processing system 100C is capable of outputting diagnosis estimation information as diagnostic information estimated by the estimation unit 120C through a machine learning means using this learning data.

FIG. 28(a) is a block diagram illustrating a configuration of the estimation unit 120C. The estimation unit 120C is physically configured by one or more computers including a central processing unit (CPU; GPU) and memory (not illustrated). The estimation unit 120C including these components includes a learning data creation unit 1250, a learning data storage unit 1251, a machine learning unit 1252, a parameter updating unit 1253, and a learning model storage unit 1254. The learning data storage unit 1251 and the learning model storage unit 1254 are constituted by memories. The learning data creation unit 1250, the machine learning unit 1252, and the parameter updating unit 1253 are functional blocks implemented by execution and interpretation of a learning program described below by the CPU (GPU) of the computer. The control unit 130C is capable of controlling information in the mounting information unit 441, the history information unit 442, and the estimation unit 404C of the database 120C through respective functions exhibited by the learning data creation unit 1250, the learning data storage unit 1251, the machine learning unit 1252, the parameter updating unit 1253, and the learning model storage unit 1254.

The learning data creation unit 1250 creates learning data by acquiring history information from the history information unit 442 of the database 404C, associating diagnostic information (objective variables) as learning labels with feature amounts (explanatory variables) included in this history information, including predetermined preprocessing (data maintenance, normalization, standardization, or data expansion, division, and the like) as learning data, and stores the learning data in the learning data storage unit 1251.

The machine learning unit 1252 acquires the learning data from the learning data storage unit 1251 by a predetermined machine learning (deep learning) means, generates a learning model capable of outputting diagnostic estimation information that is diagnostic information of the estimation unit 120C, and stores the learning model in the learning model storage unit 1254. The timing at which the learning model is stored in the learning model storage unit 1254 or the timing at which the stored learning model is updated is set as appropriate. Machine learning refers to a process of optimizing a predetermined parameter of a learning model, and the parameter updating unit 1253 has a function of updating (tuning) a parameter under the control of the control unit 130C as described below.

In addition to the estimation function by the estimation unit 120C, the information processing system 100 has a function of using all or a portion of the elements constituting the mounting information stored in the database 404C as explanatory variables. The information processing system 100 has a function of generating or updating a learning model in which all or a portion of the diagnostic information of history information associated with the mounting information (for example, only diagnostic information at the time of an abnormality) are set as objective variables.

Although a block diagram in this case is not illustrated, when description is made with reference to FIG. 28(a), the history information of the history information unit 442 is replaced with the mounting information of the mounting information unit 441 (or feature mounting information subjected to predetermined data processing so as to be suitable as input data of machine learning). Then, in the learning data creation unit 1250, history information associated with the (feature) mounting information is acquired from the database 404C. Then, learning data is created by associating all or a portion of the diagnostic information included in this history information as a set of learning labels. Then, this learning data is stored in the learning data storage unit 1251. In the machine learning unit 1252, a learning model capable of outputting history estimation information that is estimation information is generated, and this learning model is stored in the learning model storage unit 1254.

FIG. 28(b) illustrates a flowchart of when the estimation processing is executed, and further includes an operation in a case in which a learned learning model stored in the database 404C is evaluated as described below.

In the operation of the estimation processing, step S1201 is a step of acquiring data to be input to the learned learning model that has completed learning (training). As input data, real data may be input to the learning model to output estimation information, and verification data may be input to evaluate the learning model. In the case of the verification data, data in which diagnostic information (correct solution labels) is added in advance to feature amounts is used. The input data is prepared in advance in a data format that can be input to a learning model.

Step S1202 is a step of inputting the acquired input data to the learning model called from the learning model storage unit 1254. Step S3 is a step of acquiring an output value output from the learning model. The acquired output is diagnostic estimation information or history estimation information of the estimation unit 120C as described above.

In the case of data being input as verification data, a predetermined accuracy index (result of the learning model) is evaluated by comparing the acquired output value with a correct solution value labeled in advance by a statistical method suitable for the learning model. In accordance with this evaluation, the parameter updating unit 1253 tunes a predetermined parameter. Alternatively, the learning model may be newly generated by changing the learning model.

### Method of Machine Learning

As a method of machine learning by the machine learning unit 1252 described above, various known machine learning algorithms can be applied or improved and used. For example, the machine learning method in the case of acquiring the diagnosis estimation information described above can be set up as a single-label method (a multi-class classification problem where one class=one diagnostic result) in which diagnostic information of the correct solution label is attached to the learning data for each feature amount (specifically, 2-dimensional angular velocity graph image data) of the learning data, per identical mounting information.

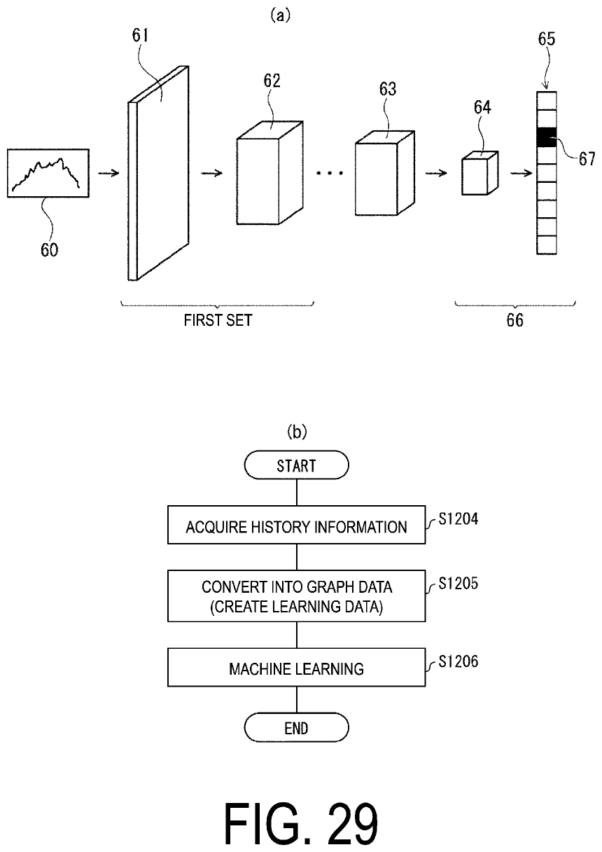

FIG. 29(a) illustrates an example of machine learning for acquiring an output of diagnosis estimation information, and is a schematic view of the machine learning unit 1252 using a convolutional neural network (hereinafter simply referred to as “CNN”). FIG. 29(b) is a flowchart of the processing by this CNN. The machine learning unit 1252 processes an input image 60, a convolution layer 61, pooling layers 62 to 64, a final layer 65, and a node 67.

The input image 60 is obtained by converting, when one or more symptoms (diagnostic results of diagnostic information) are exhibited, angular velocity information acquired from an open/close operation of the valve to which the sensor unit 1 is attached into two dimensional angular velocity graph information. Specifically, the input image 60 is image data similar to that of the graph image exemplified above. The image data may be data subjected to necessary preprocessing so as to be suitable as input information to the CNN.

The convolution layer 61 performs a convolution operation on the input image 60 using a filter having an appropriate size and extracts a plurality of primary feature maps. The pooling layer 62 connected to the subsequent stage of the convolution layer 61 performs pooling (for example, max pooling) on each of the plurality of primary feature maps output from the convolution layer 61. As a result of this computation, from the primary feature maps, secondary feature maps are generated in the same quantity as that of the primary feature maps with the amount of information reduced.

A second set of convolution layers (not illustrated) is connected to the subsequent stage of the pooling layer 62, and a second set of pooling layers is connected to the subsequent stage of this convolution layer. In this second set of layers, tertiary feature maps and quaternary feature maps are respectively output through convolution computation and pooling. Thus, the CNN is a multilayer neural network in which sets of convolution layers and pooling layers are alternately connected.

In the pooling layer 64 (n-th set) of the final stage, a 2n feature map is created from a 2n−1 feature map output from the convolution layer 63. The pooling layer 64, the final layer 65, and the node 77 of the final stage are the output layer 66, and one or more fully connected layers in which all nodes are connected to each other are provided in the vicinity of this output layer 66. Further, in the case of N classifications, the final layer 65 composed of the same number of nodes (N) as the number of classes is provided.

The final layer 65 in FIG. 29(a) schematically illustrates an output state in a case in which the correct solution is found for the input image 60. The node 67 in the drawing indicates a state in which 1 is output (probability 100%) from only the node corresponding to the diagnostic result of the valve when the input image 60 was measured, and 0 is output (probability 0%) from the other nodes. However, a probability distribution display using discrete values of 0 to 100% may be indicated.

In the machine learning by the CNN, a process of minimizing a classification error of each sample is performed on the learning data (labeled sample set). In the minimization of the classification error, for example, parameters including a filter coefficient of each convolution layer and pooling layer, a bias of each node, a weight and a bias of the fully connected layer, and the like are adjusted so that the cross-entropy using the actual output of the final layer 65 and the ideal output (correct solution) is minimized. In this adjustment processing, a stochastic gradient descent method (including a back propagation method) is most commonly used.

As described above, in the display device 200 of FIG. 26, for the feature amount to which the angular velocity graph information is input, the history information to which the diagnostic information serving as a label is attached is displayed in correspondence with the learning data.

In FIG. 29(a), the output of the final layer 65 is output as a probability by an activation function (for example, a softmax function or a sigmoid function). Therefore, the display device 200 (FIG. 26) can also display the probability corresponding to the diagnostic result. Furthermore, there is also known a method that enables output of the basis of determination of the diagnostic result. As the principle of this case, a process of appropriately extracting and representing the feature amounts that contribute to the output of the network, and displaying this result in an understandable way is performed. For example, layer-wise relevance propagation (LRP) is known as an example of a method of extracting an input having a high degree of contribution by reverse propagation from the output side to the input side. Making it possible to explain the basis of determination will become increasingly important as accountability in the future, particularly in a case in which the determination of machine learning is associated with human behavior.

FIG. 29(b) is a flowchart illustrating an example of an operation of machine learning by the CNN. In the drawing, step S1204 is a step of acquiring history information including angular velocity information (feature amounts) to which diagnostic information as labels is attached. Step S1205 is a step of converting the acquired angular velocity information into input data as two-dimensional angular velocity graph information that includes predetermined preprocessing and is information to be input to the CNN.

Step S1206 is a step of the machine learning unit 1252 inputting the input image data to the CNN for each set of mounting information, performing the machine learning computation to acquire outputs, and then calculating errors (cross-entropies) of the output values with respect to the values (diagnostic information converted into data) of the learning labels corresponding to the input image 60. Repeating step 1204 to step 1206 allows the machine learning unit 1252 to calculate an aggregate value of errors for all history information (learning data) and calculate each parameter of the CNN so that this aggregate value approaches 0 (stochastic gradient descent method). The parameter updating unit 1253 updates each parameter of the learning model stored in the learning model storage unit 1254 to the value calculated by the machine learning unit 1252. With the above, a learned learning model is created, and the flowchart is ended.

On the other hand, as the machine learning method for outputting history estimation information of the estimation unit 120C, while not illustrated in the drawing, a known multi-label machine learning method, for example, may be applied or adapted.

For example, machine learning is performed using, as multi-labels for learning, all mounting information of the mounting information unit 441 stored in the database 404C as feature amounts and all or a portion of the diagnostic information included in the history information of the history information unit 442 associated with the feature amounts in a one-to-one manner. In this case, all diagnostic information used as labels needs to be standardized in the same data format. For example, it is necessary to set the same quantity of diagnostic information acquired at the same timing (elapsed time). Learning data may be created by attaching this diagnostic information as a multi-label to the mounting information associated with this diagnostic information, and training may be performed with this learning data using a multi-label compatible CNN to create or update the learning model.

Furthermore, in the CNN described above, by providing a plurality of units corresponding to the plurality of labels in the output layer 66, a multi-label classification problem can also be applied to machine learning by the CNN. According to such a learning model, the history information (estimated multi-labels) in the form of time-series data of predetermined intervals can be output to the estimation unit 120C as future history estimation information for valves with mounting information as the input information.

### Data Transferring

As described above, at least the diagnosis estimation information of the estimation unit 120C is acquired by machine learning with the same mounting information set as one domain in the mounting information unit 441. In this case, because the mounting information of the mounting information unit 441 is composed of the unique information and the piping information, valves for which one or more of the unique information and the piping information is different also have different mounting information. Therefore, for such valves having different for such valves having different mounting information, the mounting information stored in the database 404C cannot be utilized as is, making it difficult to acquire the estimation information of the valve.

Even in such a case, when new mounting information for which the unique information and/or the piping information is not present in the database 404C is acquired by the mounting information unit 441, the information processing system 100 can transfer, on the basis of the new mounting information, mounting information of the mounting information unit 441 present in the database 404C, and thus output the estimation information of the estimation unit 120C using the learning model of this mounting information. That is, even for mounting information without history information (for example, a valve manufactured by another company), the state of the valve or the maintenance period can be predicted by using the history information of the history information unit 442 in other mounting information or the history information of other valves accumulated in the database.

Specifically, examples of a case in which the unique information is not present in the mounting information unit 441 include a valve manufactured by another company. For a valve manufactured by another company, detailed operating features are unknown. Reference is therefore made to the mounting information of a known valve having an equivalent valve nominal pressure, nominal diameter, material, or valve type. For example, in the case of a class 150 floating-type ball valve formed of SUS304 and having a nominal diameter of 100 A, reference is made to the unique information of “150UTB100,” which is a valve manufactured by the applicant and stored in the database 404C. Then, the state or maintenance period of the valve manufactured by the other company is predicted by using the history information of the history information unit 442 associated with the mounting information with this unique information.

Here, because the valve manufactured by the other company and the valve manufactured by the applicant naturally have different operating features, as the opening and closing of the valve is continued, the estimated state of the valve and the actual state of the valve increasingly differ. Therefore, new history information is added by the history information unit 442 for the mounting information in the mounting information unit 441 related to the valve, and a learning model including the new history information is generated to enable prediction with improved accuracy.

Next, in a case in which the piping information of the mounting information of the mounting information unit 441 is not present in the target plant, reference is made to the mounting information of another plant accumulated in the database 404C. Then, the mounting information having similar unique information and piping information is transferred and used as the data of the target plant. This can output the estimation information by using the learning model of the mounting information.

In these cases, it is desirable to achieve such transfers by a learning method called transfer learning in which the mounting information stored as one domain in the mounting information unit 441 is transferred and used as other mounting information of a learning model. In transfer learning, processing is performed in which a learned training model acquired from sufficiently good quality (large volume) learning data is modified when target data of a type differing from that of the domain affiliated with this learning model is acquired so as to adapt the learned model to this target data. Using transfer learning allows an existing learning model to a valve in new mounting information to be achieved by using as little feature (input image data) measured from this valve as possible. Although various known methods can be used for transfer learning, according to the present invention, desirably the following method is used.

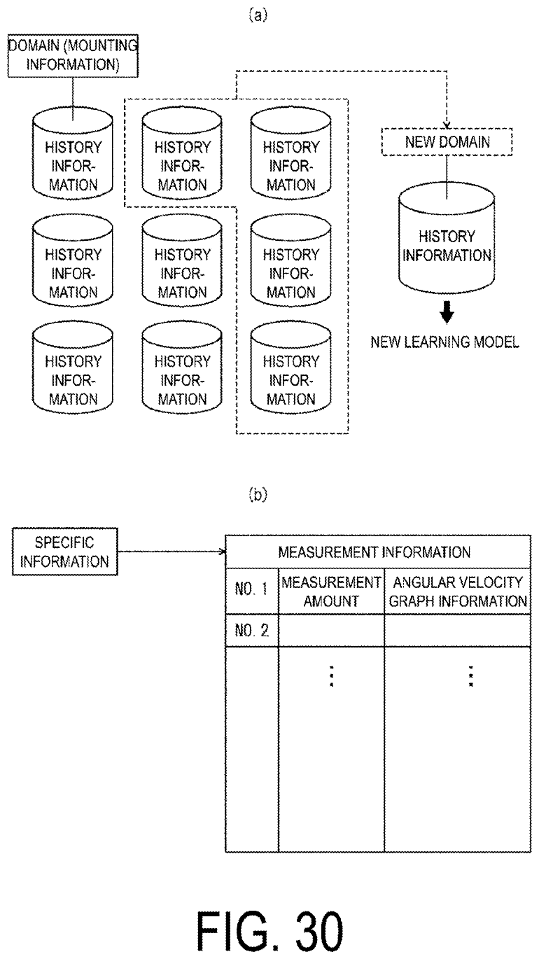

In the case of the present invention, the mounting information can be effectively utilized (transferred) as index information for generating a new domain as follows. As illustrated in FIG. 30(a), a learned learning model is associated on a per mounting information basis and thus this mounting information is regarded as one domain of the learning model. Then, when a valve (hereinafter referred to as a “new valve”) having mounting information not present in the database 404C (hereinafter referred to as “new mounting information”) is handled, a new domain (hereinafter referred to as a “new domain” as illustrated in FIG. 30(a)) is first generated on the basis of this new mounting information.

The new domain forms a set of history information having the same size (information amount) as or a larger size than that of the existing domain, and elements of the new domain at this time include unique information constituting the new mounting information (hereinafter referred to as “new unique information”) and a portion of piping information (hereinafter referred to as “new piping information”). In this case, for example, the order of the elements in the unique information and the piping information (for example, the valve type in the case of unique information and the piping diameter in the case of piping information) to be given highest priority is determined in advance, and all existing mounting information common to only those elements (one or more sets) that have high priority in the new mounting information is acquired from the database 404C, while other elements are ignored.

Specifically, for example, in a case in which the element prioritized in the unique information is only one valve type and the element prioritized in the piping information is only one piping diameter, the new mounting information in the mounting information unit 441 is composed of the valve type and the piping diameter only, and all mounting information within the same range as that of this new mounting information (the same range is determined as appropriate in advance for each element) is acquired from the database 404C. As an example, in a case in which only the valve type is to be in common and the new valve is a ball valve, all mounting information present in database 404C corresponding to a ball valve is acquired. Thus, the new mounting information can be set as appropriate in accordance with what elements are to be in common. However, when the new mounting information is excessively limited, there is a high possibility that mounting information common to the new valve is not present in the database 404C, and thus the new mounting information needs to be set to an appropriate size.

In FIG. 30(a), the new mounting information acquired in this way is set as a new domain, and a learning model is newly generated using all history information of the history information unit 442 associated with this new domain. The method of generating or updating the learning model on the basis of the history information associated with this new domain is the same as that in the case described above. This new learning model (hereinafter, a new learning model) can be retained in advance in the database 404C as mounting information, history information, or the like, even in a case other than when handling a new valve. For example, the unique information is restricted to only the ball valve as the valve type or only a few elements, and new mounting information corresponding to the new domain is set in advance. From the history information associated with this new mounting information, a general learning model for ball valves or the like can be made and retained in advance in the database 404C at each appropriate timing, for example.

The new learning model acquired in this way is affiliated with a new domain, and the history information of this new domain is learning data acquired from a valve having a feature with a certain degree of commonality with that of the new valve as described above. This ensures not only the quantity of training data samples, but also a certain level of quality as learning data. This new learning model may be used as is for a new valve. Alternatively, the new learning model may be further trained using a feature amount (input image) acquired from a new valve as learning data through a known transfer learning method, for example.

As an outline of a known transfer learning method, in the case of the CNN, a method of tuning parameters by freezing and unfreezing a portion of nodes of a network is common. In this case, it is known that high reliability can be exerted on input data affiliated with a new domain even when an existing learning model is corrected by performing relearning processing on only a portion of the network. Needless to say, transfer learning for a new learning model may be omitted.

In such transfer of the mounting information as described above, as a simpler method, for example, there is a case in which history information in one set of mounting information is utilized for a valve installed at another position. This corresponds to, for example, a case in which a new valve is provided on a common piping system line and, in this case, the pipeline position of the new valve and the mounting information of the arranged valve can be easily correspondingly transferred in the common piping system as the new mounting information.

In this case, if the piping system is the same, the usage state or the external environment is similar in many cases, and there is a high possibility that the information can be effectively utilized as the new mounting information, making it possible to utilize the mounting information of the existing valve arranged in the piping system. At this time, to generate a new domain, a domain having piping information common to the piping system provided with the new valve is acquired. In addition, it is possible to select as appropriate a domain having unique information (for example, valve type) common to that of the new valve from these domains, easily set the domain as the new domain, and utilize history information of this new domain for the new valve.

Furthermore, information may be transferred across different piping systems. As a transfer method at this time, for example, in FIG. 26, in a case in which, of the piping systems A or B, the use of system B is started after the start of the use of system A, the mounting information corresponding to the piping state of the valve unit V1 can be transferred to the mounting information corresponding to the piping state of the valve unit V3. More specifically, use of system A is started, and the history information of the history information unit 442 is accumulated in association with the mounting information of the mounting information unit 441 corresponding to the valve unit V1. Subsequently, when the use of system B is started, the history information associated with the mounting information corresponding to the valve unit V1 may be transferred as information to be used for estimating the state or detecting an abnormality (or predicting the maintenance or replacement period) of the valve unit V3. This is because the valve unit V1 and the valve unit V3 in the drawing are connected to the same device and are the first valve units from this device on the piping systems A, B connected to the device, and the usage states thereof are similar to each other (more preferably, the distances LA1, LB1 are close to each other), making it possible to making the determination of an effective transfer candidates.

If the transfer is not performed, after the start of the valve unit V3, the history information must be accumulated again in association with the mounting information. As a result, a considerable amount of time is required until utilization of the accumulated information, and in particular, a sufficient data amount is required to predict information, such as the maintenance period, with high accuracy. On the other hand, with the transfer described above, there is a high possibility that highly accurate estimation and prediction can be performed in a short time with a small amount of data processing while utilizing the existing accumulated information of the database 404C.

For example, in FIG. 26, in a case in which the valve unit V4 is a valve manufactured by another company and the database 404C lacks unique information for identifying this valve unit, the unique information of a valve unit manufactured by the company corresponding to the valve unit manufactured by the other company is transferred as described above and the standard history information of this valve unit manufactured by the company is used. This makes it possible to estimate the maintenance or replacement period of the valve unit V4 quickly and as accurately as possible.

In applying a machine algorithm as a method of machine learning by the machine learning unit 1252, an appropriate machine learning algorithm may be selected for each set of mounting information, specifically, in accordance with the unique information or the piping information. As a means for selection, a filtering function may be used. For example, selection can be made as in “Machine learning algorithm related to piping installation close to pump.”

The machine learning algorithm to be applied may be changed by partitioning the range of the open/close angles of the valve, as in, for example, “From fully closed to opening degree of 20% or less” or “Opening degree of more than 20% to opening degree of less than 80%.” Furthermore, the machine learning algorithm actually applied may be configured to be preferentially applied to the machine learning unit 1252.

### Application of System

When the angular velocity graph information is measured using the gyro sensor 7, the measurement may be limited to the angular velocity graph information as the feature amount, and the diagnostic information may be read as a predetermined measurement amount corresponding to this angular velocity graph information and applied as the processing of the estimation unit 120C. That is, in the example described above, a case in which the learning model is generated by using the diagnostic information for a label with the history information as learning data has been described. However, as described below, this label is not limited to the diagnostic information and may be the measurement amount of the valve measured by the sensor unit 1. In this case, the association per set of mounting information in the mounting information unit 441 may be replaced with per set of predetermined specific information for identifying the valve to which the sensor unit 1 is attached.

FIG. 30(b) illustrates a data structure resulting from such replacement. When the sensor unit 1 measures the angular velocity graph information from the valve unit V, the measurement amount in this case refers to information other than this angular velocity graph information that can be measured from the valve unit V by the sensor unit 1. The diameter measurement is, for example, the number of openings and closings, opening and closing time, or torque of the valve which can be measured from the opening and closing operation of the valve.

The specific information is various information necessary for identifying a valve in a usage state, such as valve type, manufacturer name, usage condition (installation environment including temperature, used fluid, or the like), or a type of component subject to wear, and may be all or a portion of the mounting information of the mounting information unit 441, for example. In this case, the mounting information can be read as specific information, the history information can be read as measurement information, the feature amount can be read as angular velocity graph information, and the diagnostic information can be read as a measurement amount when the angular velocity graph information is acquired.

In this case, a system according to an aspect of the present invention includes the rotating valve V provided in the piping systems A, B, the sensor unit 1 fixed to the rotating valve V and including the gyro sensor 7 capable of acquiring angular velocity graph information (input image) corresponding to the open/close operation of the rotating valve V and a predetermined measurement amount corresponding to this angular velocity graph information, the server 400 capable of communicating with the sensor unit 1 and including the database 404C, the display device 200 capable of communicating with this server 400 and the sensor unit 1 and including a display unit 203, and the information processing system 100C. The information processing system 100C is a system for generating a valve learning model configured to accumulate, in the database 404C, learning data with the measurement amount attached to the angular velocity graph information as a learning label for each specific condition for identifying the valve unit V and to create or update the learning model via machine learning (CNN) using this learning data.

In this case, new angular velocity graph information (input image) is input to the learning model, whereby an output of an estimated measurement amount is obtained. The valve learning model generation system may be a system that, under the automatic control of the information processing system 100, automatically acquires data from the sensor unit 1 attached to the valve V during actual operation, accumulates the acquired date in the database 404C, creates training date from this accumulated date, and generates and updates a learning model by machine learning (CNN).

Furthermore, the diagnostic information may be not only information related to symptoms (diagnostic results) of the valve and the actuator but also an actual measurement value obtained by actually measuring damage or the like of a predetermined section from the valve, such as a dimensional wear amount of a valve seat (ball seat) corresponding to when the angular velocity graph information was acquired. However, in this case, each time the angular velocity graph information is acquired, it is necessary to acquire an actual measurement amount by taking an actual measurement from the valve.

### Other

In an aspect according to the present invention, by the control of the information processing system 100C, it is possible to issue a warning on the display unit 203 of the display device 200 related to the degrees of abnormality of the valves and the actuators of the valve units V1 to V4 in a predetermined format on the basis of the diagnosis estimation information of the estimation unit 120C. On the other hand, a facility such as a plant having a piping system is typically provided with a distributed control system (DCS) in advance. Therefore, the information processing system may be configured so that the system of the present invention is communicably connected to another control system provided in advance in the plant or the like, and the warning information issued according to this aspect of the present invention can also be transmitted to the existing control system. Thus, an aspect of the present invention can be linked to another existing system.

Furthermore, an aspect of the present invention can be implemented not only as a system, but also as a program for causing a computer (computer system) to execute the system. Furthermore, the present invention can be implemented as a non-transitory computer-readable recording medium, such as a CD-ROM, on which the program is recorded.

For example, when the present invention is implemented by a program (software), each step including the steps described above is executed by executing the program using hardware resources such as a CPU, a memory, and an input/output circuit of a computer. Each step is executed by the CPU acquiring data from the memory, the input/output circuit, and the like and performing computations, outputting computation results to the memory or the input/output circuit, and the like.

In particular, each of the constituent elements included in the display device 200 or the sensor unit 1 of the embodiments described above may be implemented as a dedicated or general-purpose circuit, or may be implemented as large scale integration (LSI), which is an integrated circuit (IC). The integrated circuit is not limited to LSI and may be implemented by a dedicated circuit or a general-purpose processor. Further, a programmable field programmable gate array (FPGA) or a reconfigurable processor in which connections and configurations of circuit cells within the LSI can be reconfigured may be utilized. Furthermore, if other technologies that improve upon or are derived from semiconductor technology enable integration technology to replace LSI, then it is also possible to use those technologies to create integrated circuits for the constituent elements included in display device 200 or the sensor unit 1. In addition to this, the function of each control block described above can also be implemented by, for example, a quantum computer.

Each process described in each embodiment described above may be executed by artificial intelligence (AI). In this case, the AI may operate in the control device described above, or may operate in another device (for example, an edge computer or a cloud server).

As an aspect of the present invention, with respect to the angular velocity data of the valve unit actually measured, the degree of abnormality may be estimated (determined) by referring to the angular velocity data of an abnormal valve unit and by the degree of proximity to this data. In this case as well, a specific numerical value or a change amount in an abnormal case in a specific rotation range can be referenced and used for the estimation processing instead of the entire rotation range.

In an aspect of the invention, a group of valves and actuators may be provided so that the maintenance period is substantially the same. For example, the type of seal in the case of a valve and the waterproof structure in the case of an actuator are adjusted as appropriate according to the conditions of the installation locations and frequencies of use thereof. More specifically, high performance seals are used for valves with severe operating conditions and more versatile seals are used for valves with milder operating conditions. In this way, determining the configuration of the valve and the actuator according to the estimated maintenance period is more effective from the viewpoint of efficient maintenance of the valve system and allows cost reduction of the valve system and the maintenance thereof to be expected.

As an aspect of the present invention, a blockchain may be further applied to manage an aspect of teaching data or a learning result. Such an aspect can enhance traceability related to machine learning. Accordingly, the aspect described above is advantageous from the viewpoint of preventing unintended biased data from being used in machine learning and improving the accuracy and reliability of machine learning.

The present invention is not limited to the embodiments described above, and various changes can be made within the scope of the claims. Any embodiment based on a proper combination of technical means disclosed in different embodiments is also encompassed in the technical scope of the present invention.

### SUMMARY

According to a first aspect of the present invention, an information processing system includes an acquisition unit configured to acquire angular velocity data of a rotation of a rotating shaft, the angular velocity data being detected by an angular velocity sensor, in a valve unit in which the rotating shaft is rotated by an actuator to rotate a valve body of a valve and an estimation unit configured to estimate a degree of abnormality of each of the actuator and the valve by referring to the angular velocity data acquired by the acquisition unit.

According to the configuration of the first aspect, it is possible to estimate the degrees of abnormality of both the valve and the actuator.

According to a second aspect of the present invention, in the information processing system according to the first aspect, the estimation unit estimates the degree of abnormality of each of the actuator and the valve on the basis of a numerical value of the angular velocity data corresponding to an opening degree of the valve.

According to the configuration of the second aspect, it is possible to estimate the degrees of abnormality of both the valve and the actuator from a numerical value of the angular velocity data.

According to a third aspect of the present invention, in the information processing system according to the second aspect, the estimation unit estimates the degree of abnormality of the valve on the basis of numerical values of the angular velocity data at an initial stage of rotation and an end stage of rotation of the valve body and estimates the degree of abnormality of the actuator on the basis of a numerical value of the angular velocity data in a rotation of the valve body other than at the initial stage of rotation and the end stage of rotation.

According to the configuration of the third aspect, the rotation period of the valve body is divided into the rotation period in which the degree of abnormality of the valve can be estimated and the rotation period in which the degree of abnormality of the actuator can be estimated, and the degrees of abnormality of both the valve and the actuator can be efficiently estimated from a series of rotations of the valve.

According to a fourth aspect of the present invention, in the information processing system according to the first to third aspects, the estimation unit estimates the degree of abnormality by referring to comparative angular velocity data acquired by detecting a rotation of the rotating shaft of a normal valve unit by using an angular velocity sensor and comparing the angular velocity data acquired by the acquisition unit with the comparative angular velocity data.

According to the configuration of the fourth aspect, it is possible to quickly estimate the degrees of abnormality by comparison.

According to a fifth aspect of the present invention, the information processing system according to the first to fourth aspects further includes a sensor control unit configured to control the angular velocity sensor, and the sensor control unit activates the angular velocity sensor in a specific time period.

According to the configuration of the fifth aspect, the operation period of the angular velocity sensor can be limited to a specific period, making it possible to suppress the power consumption amount of the angular velocity sensor.

According to a sixth aspect of the present invention, the information processing system according to the first to fifth aspects further includes a sensor control unit configured to control the angular velocity sensor, the acquisition unit further acquires a detection signal of a start of rotation of the rotating shaft from a sensor for detecting rotation of the rotating shaft, and the sensor control unit activates the angular velocity sensor in response to the number of times the acquisition unit acquires the detection signal of the start of rotation of the rotating shaft reaching a specific count.

According to the configuration of the sixth aspect, the angular velocity sensor can be brought into a stop (sleep) state until the number of times of acquisition of the detection signal reaches a specific count. This can reduce the power consumption of the angular velocity sensor.

According to a seventh aspect of the present invention, the information processing system according to the first to sixth aspects further includes a transmission control unit configured to control transmission from the angular velocity sensor to the acquisition unit, and the transmission control unit transmits, to the acquisition unit, the angular velocity data in response to one or both of a specific time period and the number of times the angular velocity sensor detects the angular velocity data of the rotating shaft reaching a specific count.

According to the configuration of the seventh aspect, it is possible to reduce the number of times data is transmitted to the acquisition unit and suppress the power consumption related to transmission.

According to an eighth aspect of the present invention, the information processing system according to the first to sixth aspects further includes a transmission control unit configured to control transmission from the angular velocity sensor to the acquisition unit, and the transmission control unit transmits, to the acquisition unit, data of a representative value representing a behavior of a certain rotating shaft based on a plurality of angular velocity data detected by the angular velocity sensor configured to detect the angular velocity data of the certain rotating shaft.

According to the configuration of the eighth aspect, the data of the representative value representing the behavior of the rotating shaft is transmitted to the acquisition unit, making it possible to reduce the amount of data related to transmission compared with a case in which the angular velocity data of a certain rotating shaft is transmitted as is and all detected angular velocity data are transmitted. The amount of data to be transmitted is reduced, allowing the power consumption related to transmission to be reduced.

According to the ninth aspect of the present invention, the information processing system according to the first to eighth aspects described above further includes a determination unit configured to determine whether to perform maintenance work of one or both of the valve and the actuator on the basis of an estimation result of the estimation unit.

According to the configuration of the ninth aspect, maintenance work of the valve unit is performed as necessary, allowing an information processing system equipped with a valve unit having high reliability to be implemented.

According to a tenth aspect of the present invention, in the information processing system according to the ninth aspect, the acquisition unit acquire angular velocity data of each of the rotating shafts of a group of the valves, and the determination unit determines whether to collectively perform the maintenance work of individual valves and actuators in one or both of a group of valves and a group of actuators on the basis of the estimation result of the estimation unit corresponding to the angular velocity data of the rotating shafts of the group of valves acquired by the acquisition unit.

According to the configuration of the tenth aspect, it is possible to determine whether to collectively perform the maintenance work of the individual valves and actuators, making it possible to suppress the cost related to the maintenance work to a low value compared with a case in which the maintenance work is individually performed for both the valves and the actuators.

According to an eleventh aspect of the present invention, in the information processing system according to the first to tenth aspects, the valve body is a ball valve or a butterfly valve.

According to a twelfth aspect of the present invention, in the information processing system according to the first to eleventh aspects, the actuator is a pneumatic actuator.

According to the configuration of the twelfth aspect, even if the actuator is a pneumatic actuator without a power supply, the system can be maintained over a long period of time by, for example, considering the detection frequency of the angular velocity data or suppressing the data transmission amount or the power amount related to the transmission as described above.

According to a thirteenth aspect of the present invention, a transmission system transmit, to an external device, angular velocity data of a rotation of a rotating shaft, the angular velocity data being detected by an angular velocity sensor, in a valve unit in which the rotating shaft is rotated by an actuator to rotate a valve body of a valve in order to estimate a degree of abnormality of each of the actuator and the valve by referring to the angular velocity data. The transmission system includes a transmission control unit configured to control transmission of the angular velocity data. The transmission control unit transmits, of a plurality of the angular velocity data detected by the angular velocity sensor, only some of angular velocity data to the external device in response to one or both of a specific time period and the number of times the angular velocity sensor detects the angular velocity data of the rotating shaft reaching a specific count.

According to the configuration of the thirteenth aspect, it is possible to reduce the number of times data is transmitted to an external device and suppress the power consumption related to transmission.

According to a fourteenth aspect of the present invention, in the transmission system according to the thirteenth aspect, the transmission control unit transmits, to the external device, data of a representative value representing a behavior of a certain rotating shaft based on a plurality of angular velocity data detected by the angular velocity sensor configured to detect the angular velocity data of the certain rotating shaft.

According to the configuration of the fourteenth aspect, the data of the representative value representing the behavior of the rotating shaft is transmitted to an external device, making it possible to reduce the amount of data related to transmission compared with a case in which the angular velocity data of a certain rotating shaft is transmitted as is and all detected angular velocity data are transmitted. The amount of data to be transmitted is reduced, allowing the power consumption related to transmission to be reduced.

According to a fifteenth aspect of the present invention, an information processing method includes acquiring angular velocity data of a rotation of a rotating shaft, the angular velocity data being detected by an angular velocity sensor, in a valve unit in which the rotating shaft is rotated by an actuator to rotate a valve body of a valve and estimating a degree of abnormality of each of the actuator and the valve by referring to the angular velocity data acquired by the acquiring.

According to the configuration of the fifteenth aspect, it is possible to estimate the degrees of abnormality of both the valve and the actuator.

According to a sixteenth aspect of the present invention, the information processing method according to the fifteenth aspect further includes determining whether to perform maintenance work of one or both of the valve and the actuator on the basis of an estimation result of the estimating.

According to the configuration of the sixteenth aspect, maintenance work of the valve unit is performed as necessary, making it possible to provide a valve unit having high reliability.

According to a seventeenth aspect of the present invention, in the information processing method according to the sixteenth aspect, the acquiring includes acquiring angular velocity data of each of the rotating shafts of a group of the valves, and the determining includes determining whether to collectively perform the maintenance work of individual valves and actuators in one or both of a group of valves and a group of actuators on the basis of the estimation result of the estimating corresponding to the angular velocity.

According to the configuration of the seventeenth aspect, it is possible to determine whether to collectively perform the maintenance work of the individual valves and actuators, making it possible to suppress the cost related to the maintenance work to a low value compared with a case in which the maintenance work is individually performed for both the valves and the actuators.

According to an eighteenth aspect of the present invention, a valve system according includes a valve unit including a valve configured to open and close a flow path by rotating a valve body and an actuator configured to rotate a rotating shaft for rotating the valve body, and one or both of the information processing system described above and the transmission system described above.

According to the configuration of the eighteenth aspect, both the valve and the actuator are maintained at an appropriate time on the basis of the angular velocity data, making it possible to provide a valve system having high reliability.

According to the configuration described above, it is possible to estimate an abnormality of a valve unit with high accuracy. Thus, the present invention is expected to contribute to the maintenance of infrastructure and to the achievement of sustainable development goals (SDGs) on the basis of industry and technological innovation.

### REFERENCE SIGNS LIST

1 Sensor unit
2 Actuator
3 Valve
4 Control shaft (rotating shaft)
7 Gyro sensor
8 CPU
14 Output shaft (rotating shaft)
15 Stem (rotating shaft)
30 Ball (valve body)
400 Server
100, 100A, 100B, 100C Information processing system
110 Acquisition unit
120, 120C Estimation unit
130, 130A, 130B, 130C Control unit
131 Sensor control element (sensor control unit)
132 Transmission control element (transmission control unit)
404, 404C Database
500 Valve system
600 Gateway
700 Second sensor
A1 Ball seat
V1, V2, V3, V4 Valve unit

1. An information processing system, comprising:
an acquisition unit configured to acquire angular velocity data of a rotation of a rotating shaft, the angular velocity data being detected by an angular velocity sensor, in a valve unit in which the rotating shaft is rotated by an actuator to rotate a valve body of a valve; and
an estimation unit configured to estimate a degree of abnormality of each of the actuator and the valve by referring to the angular velocity data acquired by the acquisition unit.

2. The information processing system according to claim 1, wherein the estimation unit estimates the degree of abnormality of each of the actuator and the valve in accordance with a numerical value of the angular velocity data corresponding to an opening degree of the valve.

3. The information processing system according to claim 2, wherein
the estimation unit
estimates the degree of abnormality of the valve in accordance with numerical values of the angular velocity data at an initial stage of rotation and an end stage of rotation of the valve body and
estimates the degree of abnormality of the actuator in accordance with a numerical value of the angular velocity data in a rotation of the valve body other than at the initial stage of rotation and the end stage of rotation.

4. The information processing system according to claim 1, wherein the estimation unit estimates the degree of abnormality by referring to comparative angular velocity data acquired by detecting a rotation of the rotating shaft of a normal valve unit by using an angular velocity sensor and comparing the angular velocity data acquired by the acquisition unit with the comparative angular velocity data.

5. The information processing system according to claim 1, further comprising
a sensor control unit configured to control the angular velocity sensor, wherein
the sensor control unit activates the angular velocity sensor in a specific time period.

6. The information processing system according to claim 1, further comprising
a sensor control unit configured to control the angular velocity sensor, wherein
the acquisition unit further acquires a detection signal of a start of rotation of the rotating shaft from a sensor for detecting rotation of the rotating shaft, and
the sensor control unit activates the angular velocity sensor in response to the number of times the acquisition unit acquires the detection signal of the start of rotation of the rotating shaft reaching a specific count.

7. The information processing system according to claim 1, further comprising:
a transmission control unit configured to control transmission from the angular velocity sensor to the acquisition unit, wherein
the transmission control unit transmits, to the acquisition unit, the angular velocity data in response to one or both of a specific time period and the number of times the angular velocity sensor detects the angular velocity data of the rotating shaft reaching a specific count.

8. The information processing system according to claim 1, further comprising
a transmission control unit configured to control transmission from the angular velocity sensor to the acquisition unit, wherein
the transmission control unit transmits, to the acquisition unit, data of a representative value representing a behavior of a certain rotating shaft based on a plurality of angular velocity data detected by the angular velocity sensor configured to detect the angular velocity data of the certain rotating shaft.

9. The information processing system according to claim 1, further comprising
a determination unit configured to determine whether to perform maintenance work of one or both of the valve and the actuator in accordance with an estimation result of the estimation unit.

10. The information processing system according to claim 9, wherein
the acquisition unit acquires angular velocity data of each of the rotating shafts of a group of the valves, and
the determination unit determines whether to collectively perform the maintenance work of individual valves and actuators in one or both of a group of valves and a group of actuators in accordance with the estimation result of the estimation unit corresponding to the angular velocity data of the rotating shafts of the group of valves acquired by the acquisition unit.

11. The information processing system according to claim 1, wherein the valve body is a ball valve or a butterfly valve.

12. The information processing system according to claim 1, wherein the actuator is a pneumatic actuator.

13. A transmission system configured to transmit, to an external device, angular velocity data of a rotation of a rotating shaft, the angular velocity data being detected by an angular velocity sensor, in a valve unit in which the rotating shaft is rotated by an actuator to rotate a valve body of a valve in order to estimate a degree of abnormality of each of the actuator and the valve by referring to the angular velocity data, the transmission system comprising
a transmission control unit configured to control transmission of the angular velocity data, wherein
the transmission control unit transmits, of a plurality of the angular velocity data detected by the angular velocity sensor, only some of angular velocity data to the external device in response to one or both of a specific time period and the number of times the angular velocity sensor detects the angular velocity data of the rotating shaft reaching a specific count.

14. The transmission system according to claim 13, wherein the transmission control unit transmits, to the external device, data of a representative value representing a behavior of a certain rotating shaft based on a plurality of angular velocity data detected by the angular velocity sensor configured to detect the angular velocity data of the certain rotating shaft.

15. An information processing method, comprising:
acquiring angular velocity data of a rotation of a rotating shaft, the angular velocity data being detected by an angular velocity sensor, in a valve unit in which the rotating shaft is rotated by an actuator to rotate a valve body of a valve; and
estimating a degree of abnormality of each of the actuator and the valve by referring to the angular velocity data acquired by the acquiring.

16. The information processing method according to claim 15, further comprising
determining whether to perform maintenance work of one or both of the valve and the actuator in accordance with an estimation result of the estimating.

17. The information processing method according to claim 16, wherein
the acquiring includes acquiring angular velocity data of each of the rotating shafts of a group of the valves, and
the determining includes determining whether to collectively perform the maintenance work of individual valves and actuators in one or both of a group of valves and a group of actuators in accordance with the estimation result of the estimating corresponding to the angular velocity data of the rotating shafts of the group of valves acquired by the acquiring.

18. A valve system, comprising:
a valve unit including
a valve configured to open and close a flow path by rotating a valve body and
an actuator configured to rotate a rotating shaft for rotating the valve body; and
one or both of an information processing system and a transmission system, wherein
the information processing system comprises: an acquisition unit configured to acquire angular velocity data of a rotation of the rotating shaft, the angular velocity data being detected by an angular velocity sensor, in the valve unit; and an estimation unit configured to estimate a degree of abnormality of each of the actuator and the valve by referring to the angular velocity data acquired by the acquisition unit, and
the transmission system is configured to transmit, to an external device, the angular velocity data of the rotation of the rotating shaft, the angular velocity data being detected by the angular velocity sensor, in the valve unit in order to estimate a degree of abnormality of each of the actuator and the valve by referring to the angular velocity data, the transmission system comprising a transmission control unit configured to control transmission of the angular velocity data, wherein the transmission control unit transmits, of a plurality of the angular velocity data detected by the angular velocity sensor, only some of angular velocity data to the external device in response to one or both of a specific time period and the number of times the angular velocity sensor detects the angular velocity data of the rotating shaft reaching a specific count.
